(19) United States
(12) Patent Application Publication
(10) Pub. No.: US 2005/0198656 A1
(43) Pub. Date: Sep. 8, 2005

(54) Disc drive device

(75) Inventors: Kazuyuki Yamamoto, Kanagawa (JP); Hideaki Kumagai, Kanagawa (JP); Takashi Yamada, Tokyo (JP); Toshio Mamiya, Tokyo (JP); Takashi Aoyama, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/000,246

(22) Filed: Dec. 1, 2004

(30) Foreign Application Priority Data
Dec. 5, 2003 (JP) P2003-408087
Dec. 5, 2003 (JP) P2003-408089
Jun. 1, 2004 (JP) P2004-190512
Jun. 1, 2004 (JP) P2004-163905

(51) Int. Cl. G11B 17/03; G11B 17/04; G11B 33/02

(52) U.S. Cl. 720/616; 720/619

(57) ABSTRACT

Disclosed is an ultra-thin slot-in disc drive device capable of coping with discs with different outer diameters. The outer rim of a disc 2, inserted via a disc inserting/ejecting opening 19, is held in-between a pair of rotational arms 35, 36, rotationally driven between the major surface of the device facing a disc loading unit 23 and the major surface of the disc 2 inserted via the disc inserting/ejecting opening 19. In this state, the loading operation of retracting the disc 2 via the disc inserting/ejecting opening 19 into the inside of the casing 3, the centering operation of setting the disc 2 in the disc loading unit 23 and the ejecting operation of ejecting the disc 2 through the disc inserting/ejecting opening 19 to outside the casing 3, are carried out.

### BACKGROUND OF THE INVENTION

1. Field of the Invention

This invention relates to a disc drive device for recording and/or reproducing information signals for an optical disc and, more particularly, to a slot-in disc drive device.

This application claims priority of Japanese Patent Application No. 2003-408087, filed on Dec. 5, 2003, the entirety of which is incorporated by reference herein.

2. Description of Related Art

As optical discs, optical discs, such as CD (Compact Disk) or DVD (Digital Versatile Disk), or photo-magnetic discs, such as MO (magneto-optical) or MD (Mini-Disk), have so far been known, and a variety of disc drive devices for coping with these discs or disc cartridges have made their debut.

Among the disc drive device types, there are such a device type in which a lid or a door provided to the front side of a casing is opened and a disc is directly loaded on a table exposed, such a type in which a disc is set on a disc tray projected from or retracted into the casing horizontally and the disc may be automatically loaded on the turntable, provided inside the casing, on retracting the disc tray, and such a device type in which the disc is directly loaded on the turntable provided on this disc tray. However, in these device types, an operator has to perform such operations as opening or closing a lid or a door, drawing out or retracting the disc tray, or loading the disc on the turntable.

On the other hand, there is a so-called slot-in type disc drive device in which the disc is automatically loaded on the turntable simply on introducing the disc via a disc inserting/ejecting opening provided in the front surface of the casing. In this disc drive device, when the disc is inserted via the disc inserting/ejecting opening, the loading operation of retracting the disc, introduced via the disc inserting/ejecting opening, into the inside of the casing, and the ejecting operation of ejecting the disc to outside the casing via the disc inserting/ejecting opening, are carried out by rotating a pair of guide rolls, facing each other with the disc in-between, in relatively opposite directions.

It is noted that, in a mobile device, such as a notebook personal computer, carrying a disc drive device, it is a requirement to reduce the size and weight of the mobile device, and hence the size and weight of the disc drive device further. Moreover, there is recently a demand for a slot-in type disc drive device, rather than a tray type disc drive device, which has been the mainstream in a personal computer, in view that the slot-in type disc drive device is more user-friendly than the tray type disc drive device.

However, with the slot-in disc drive device, in which the length of the paired guide rolls is longer than the disc diameter, the size along the width of the overall device is increased. Since the disc is sandwiched between the paired guide rolls, the device is increased in the size along the thickness. Consequently, the conventional disc drive device is extremely unfavorable for reduction in size or thickness.

In particular, in an ultra-thin disc drive device loaded on a notebook personal computer, the standard size is 12.7 mm. If the device is further reduced in size to a thin thickness of 9.5 mm which is equivalent to the thickness of a hard disc device (HDD), this guide roll cannot be directly use-diverted with ease by reason of size.

In a proposal in a slot-in disc drive device, a plural number of rotational arms are arranged between a disc introduced via a disc inserting/ejecting opening and a base unit carrying a turntable loaded with the disc, and the loading operation of retracting the disc into the inside of the casing through the disc inserting/ejecting opening and the ejecting operation of ejecting the disc to outside the casing through the disc inserting/ejecting opening are carried out as these rotational arms are rotated in a plane parallel to the disc (see for example the Patent Publication 1).

However, the disc drive device described in the Patent publication 1 is able to cope only with the disc of the standard size with the diameter of 12 cm. Thus, if a disc different in outer diameter from the standard size, such as a small diameter disc with a diameter of 8 cm, used in e.g., a single CD or a DVD for recording, used in a camcorder, is inserted via the disc inserting/ejecting opening, such small diameter disc is forcedly ejected via the disc inserting/ejecting-opening. That is, with the disc drive device, having plural rotational arms, as stated in the above Patent Publication 1, it is not possible to effect the centering operation of setting the discs of different outer diameters in the disc mounting positions.

On the other hand, with conventional slot-in type disc drive devices, loaded in certain DVD players for AV, discs with different outer diameters can be coped with. However, the thickness not less than 40 mm is needed, while the number of components parts is increased. Consequently, the conventional mechanisms cannot directly be diverted to an ultra-thin disc drive device with a thickness of 12.7 mm or a thickness of 9.5 mm.

Among the tray type disc drive devices, there is such a device in which a ring-shaped adapter is mounted to a disc with a diameter of 8 cm in order to cope with discs of different outer diameters. However, such adapter mounting operation is onerous and labor-consuming for the user. Moreover, since the adapter is low in mounting reliability with respect to the disc, such that, if an optical disc fitted with an adapter is to be mounted on the turntable of the slot-in disc drive device, not only is the centering operation unstable, but also the adapter is likely to descend from the disc to graze the disc or to damage the drive device.

In the disc drive device, stated in the Patent Publication 1, the base unit is uplifted after the aforementioned centering operation to get the disc mounted on the turntable by way of performing the chuck operation. In such case, the clearance between the disc and the base unit during chuck operations is extremely narrow. Hence, in uplifting the base unit to load the disc on the turntable, the rotational arms need to be positioned outside the base unit in order to avoid possible collision between the rotational arms and the base unit.

In the case of the disc with the diameter of 12 cm, the rotational arms, holding the outer rim of the disc, is positioned outside the base unit, and hence there is raised no problem of collision between the rotational arms and base unit. Conversely, with the disc with the diameter of 8 cm, the rotational arms, holding the outer rim of the disc, are positioned on the base unit, such that the rotational arms holding the outer rim of the disc contact the disc to scratch the disc or deform the rotational arms.

[Patent Publication 1] Japanese Laid-Open Patent Publication 2002-117604

### SUMMARY OF THE INVENTION

In view of the above-described status of the art, it is an object of the present invention to provide a slot-in disc drive device in which the overall device can be further reduced in size and in thickness, without being affected by the clearance between the optical disc inserted via the disc inserting/ejecting opening, such that discs of different outer diameters can be coped with.

For accomplishing the above object, the present invention provides a disc driving device comprising a casing having a disc inserting/ejecting opening in a front surface thereof, a base unit including a disc loading unit, loaded with an optical disc inserted via the disc inserting/ejecting opening into the inside of the casing, a disc rotating and driving mechanism for rotating and driving the optical disc loaded on the disc loading unit, an optical pickup for writing and/or reading out signals for the optical disc rotated and driven by the disc rotating and driving mechanism, and an optical pickup feed unit for feeding the optical pickup across the inner and outer rims of the optical disc. The disc loading unit, disc rotating and driving mechanism, optical pickup and the optical pickup feed unit are formed as one with a base member. The disc drive device also includes a disc transport mechanism for transporting the optical disc between a disc inserting/ejecting position of inserting/ejecting the optical disc via the disc inserting/ejecting opening and a disc loading position of loading the optical disc on the disc loading unit. The disc transport mechanism includes a plurality of support members moved between the major surface of the casing facing the disc loading unit and the major surface of the of the optical disc introduced via the disc inserting/ejecting opening. The plural support members include abutment parts that may be abutted against the outer rim of the optical disc introduced via the disc inserting/ejecting opening, and execute at least one of the loading operation of retracting the optical disc via the disc inserting/ejecting opening into the inside of the casing, the centering operation of setting the optical disc in the disc loading position, and the ejecting operation of ejecting the optical disc to outside the casing through the inserting/ejecting opening, as the outer rim of the optical disc is sandwiched by said abutment parts.

With the disc driving device, according to the present invention, the loading operation, centering operation or the ejecting operation for the optical disc may be executed properly in stability by plural support members, without being affected by the clearance between the optical disc inserted via the disc inserting/ejecting opening and the base unit, and hence the device as the slot-in disc drive device may be further reduced in size and weight. Moreover, the optical discs with different outer diameters may be coped with.

### BRIEF DESCRIPTION OF THE DRAWINGS

FIG. 1 is a perspective view showing the appearance of a notebook personal computer loaded with a disc drive device.

FIG. 2 is a perspective view showing the appearance of the disc drive device.

FIG. 3 is a perspective view showing a top cover from its inner side.

FIG. 4 is a plan view showing the structure of the disc drive device.

FIG. 5 is a perspective view showing the structure of a base unit.

FIG. 6, illustrating the operation of a disc drive device, is a plan view showing an initial state thereof.

FIG. 7, illustrating the operation of a disc drive device, is a plan view showing the state of starting the insertion of the large diameter disc.

FIG. 8, illustrating the operation of a disc drive device, is a plan view showing the state of starting the retraction of the large diameter disc.

FIG. 9, illustrating the operation of a disc drive device, is a plan view showing the state of delivery at the time of retraction of the large diameter disc.

FIG. 10, illustrating the operation of a disc drive device, is a plan view showing the centering state of the large diameter disc.

FIG. 11, illustrating the operation of a disc drive device, is a plan view showing the state of chucking the large diameter disc.

FIG. 12, illustrating the operation of a disc drive device, is a plan view showing the state of chuck releasing the large diameter disc.

FIG. 13, illustrating the operation of a disc drive device, is a plan view showing the state of ejection of the large diameter disc.

FIG. 14, illustrating the operation of a disc drive device, is a plan view showing the state of delivery at the time of ejecting the large diameter disc.

FIG. 15, illustrating the operation of a disc drive device, is a plan view showing the state of completion of ejection of the large diameter disc.

FIG. 16, illustrating the operation of a disc drive device, is a plan view showing the state of starting the insertion of a small diameter disc.

FIG. 17, illustrating the operation of a disc drive device, is a plan view showing the state of starting the retraction of the small diameter disc.

FIG. 18, illustrating the operation of a disc drive device, is a plan view showing the state of delivery at the time of retracting the small diameter disc.

FIG. 19, illustrating the operation of a disc drive device, is a plan view showing the state of centering of the small diameter disc.

FIG. 20, illustrating the operation of a disc drive device, is a plan view showing the state of chucking of the small diameter disc.

FIG. 21, illustrating the operation of a disc drive device, is a plan view showing the state of chuck releasing of the large diameter disc.

FIG. 22, illustrating the operation of a disc drive device, is a plan view showing the state of ejection of the small diameter disc.

FIG. 23, illustrating the operation of a disc drive device, is a plan view showing the state of delivery at the time of ejecting the small diameter disc.

FIG. 24, illustrating the operation of a disc drive device, is a plan view showing the state of completion of ejection of the small diameter disc.

FIG. 25, illustrating the operation of a disc drive device, is a plan view showing the state of overstroke at the time of ejection of the small diameter disc.

FIG. 26, illustrating the operation of a disc drive device, is a side view showing the chuck releasing state of a base unit.

FIG. 27, illustrating the operation of a disc drive device, is a side view showing the state in which the base unit is in a chucked state.

FIG. 28, illustrating the operation of a disc drive device, is a side view showing the state in which the base unit is at an intermediate position.

FIG. 29 is a schematic view for illustrating the centering operation for a large diameter disc and a small diameter disc.

FIG. 30 is a plan view showing a first modification of a disc drive device.

FIG. 31 is a schematic view showing the centering operation of a large diameter disc and a small diameter disc of the first modification.

FIG. 32 is a plan view showing a second modification of a disc drive device.

FIG. 33 is a plan view showing the state in which a top cover of the disc drive device has been removed.

FIG. 34 is a plan view showing the state in which certain components of the disc drive device have been removed.

FIG. 35 is a plan view showing the state in which further components of the disc drive device have been removed.

FIG. 36 is a plan view showing the position relationship between a detection switch and a driving lever of the disc drive device.

FIG. 37a is a side view showing a driving lever from one side, FIG. 37b is a plan view showing the driving lever from above, FIG. 37c is a side view showing the driving lever from the other side and FIG. 37d is a plan view showing the driving lever from below.

FIG. 38a is a plan view showing the structure of a cam lever and FIG. 38b is a side view showing the structure of a cam lever.

FIG. 39a is a plan view showing a driving lever during loading from below and FIG. 39b is a plan view showing the driving lever from above.

FIG. 40a is a plan view showing a driving lever at the time of ejection from below and FIG. 40b is a plan view showing the driving lever from above.

FIG. 41, illustrating the operation of the disc drive device, is a plan view showing the state of starting the insertion of a large diameter disc.

FIG. 42, illustrating the operation of the disc drive device, is a plan view showing the state of starting the insertion of the large diameter disc.

FIG. 43, illustrating the operation of the disc drive device, is a plan view showing the state of centering of the large diameter disc.

FIG. 44, illustrating the operation of the disc drive device, is a plan view showing the state of completion of the chucking of the large diameter disc.

FIG. 45, illustrating the operation of the disc drive device, is a plan view showing the state of recording and/or reproducing the large diameter disc.

FIG. 46, illustrating the operation of the disc drive device, is a plan view showing the state of ejection of the large diameter disc.

FIG. 47, illustrating the operation of the disc drive device, is a plan view showing the state of completion of ejection of the large diameter disc.

FIG. 48, illustrating the operation of the disc drive device, is a plan view showing the state of start of insertion of the small diameter disc.

FIG. 49, illustrating the operation of the disc drive device, is a plan view showing the state of start of loading of the small diameter disc.

FIG. 50, illustrating the operation of the disc drive device, is a plan view showing the state of centering of the small diameter disc.

FIG. 51, illustrating the operation of the disc drive device, is a plan view showing the state of completion of chucking of the small diameter disc.

FIG. 52, illustrating the operation of the disc drive device, is a plan view showing the state of recording and/or reproducing the small diameter disc.

FIG. 53, illustrating the operation of the disc drive device, is a plan view showing the state of ejection of the small diameter disc.

FIG. 54, illustrating the operation of the disc drive device, is a plan view showing the state of completion of ejection of the small diameter disc.

FIG. 55, illustrating the operation of the disc drive device, is a plan view showing the state in which the small diameter disc has been inserted offset to one side.

FIGS. 56a to 56f is a plan view for illustrating the operation of a third rotational arm during ejection.

FIG. 57 is a schematic plan view showing the state of engagement between a thrusting lever and a driving lever.

FIGS. 58a to 58d illustrate the operation of a base lift mechanism, where FIG. 58a is a plan view in case the base unit is the chuck releasing position, FIG. 58b is a side view showing the position relationship between a first pivot of a base in the chuck releasing position and a first cam slit of the driving lever, FIG. 58c is a side view showing the position relationship between a second pivot of the base in the chuck releasing position and a second cam slit of a cam piece and FIG. 58d is a side view showing a base unit position in the chuck releasing position.

FIGS. 59a to 59d illustrate the operation of the base lift mechanism, where FIG. 59a is a plan view showing the state in which the base unit is in a chuck position, FIG. 59b is a side view showing the position relationship between a first pivot of a base in the chuck position and a first cam slit of the driving lever, FIG. 58c is a side view showing the position relationship between a second pivot of the base in the chuck position and a second cam slit of a cam piece and FIG. 58d is a side view showing a base unit position in the chuck position.

FIGS. 60a to 60d illustrate the operation of the base lift mechanism, where FIG. 60a is a plan view showing the state in which the base unit is in an intermediate position, FIG. 60b is a side view showing the position relationship between a first pivot of a base in the intermediate position and a first cam slit of the driving lever, FIG. 58c is a side view showing the position relationship between a second pivot of the base in the intermediate position and a second cam slit of a cam piece and FIG. 58d is a side view showing a base unit position in the intermediate position.

FIG. 61 is a timing chart showing the changeover state of the first to fourth switches at the time of the disc-present initial-operation of the disc drive device.

FIG. 62 is a timing chart showing the changeover state of the first to fourth switches at the time of the disc-absent initial-operation of the disc drive device.

FIG. 63 is a timing chart showing the changeover state of the first to fourth switches at the time of the loading operation of the disc drive device.

FIG. 64 is a timing chart showing the changeover state of the first to fourth switches at the time of the ejecting operation of the large diameter disc of the disc drive device.

FIG. 65 is a timing chart showing the changeover state of the first to fourth switches at the time of the ejecting operation of the small diameter disc of the disc drive device.

FIG. 66 is a plan view showing the position relationships among a first disc guide mechanism, a second disc guide mechanism, a shutter opening/closing mechanism and a small diameter disc.

FIG. 67 is a plan view showing the position relationships among a first disc guide mechanism, a second disc guide mechanism, a shutter opening/closing mechanism, a large diameter disc and a small diameter disc.

FIG. 68 is a schematic view showing the structure of a first disc guide mechanism.

FIG. 69 is a schematic front view showing the structure of the shutter opening/closing mechanism.

FIGS. 70a and 70b illustrate the operation of the first disc guide mechanism and the shutter opening/closing mechanism, where FIG. 70a is a cross-sectional view showing the state in which the base unit is in the chuck releasing position and FIG. 70b is a cross-sectional view showing the state in which the base unit is in the recording and/or reproducing position.

FIGS. 71a and 71b illustrates the operation of a second disc guide mechanism, where FIG. 71a is a cross-sectional view showing the state in which the base unit is in the chuck releasing position and FIG. 71b is a cross-sectional view showing the state in which the base unit is in the recording and/or reproducing position.

FIG. 72 is a plan view showing the top cover from its inner side.

FIG. 73 is a plan view showing the position relationship between a bead part of the top cover and first and second rotational arms.

FIG. 74 is a plan view showing another illustrative structure of a disc drive device according to the present invention.

### DESCRIPTION OF THE PREFERRED EMBODIMENTS

Referring now to the drawings, certain preferred embodiments of a disc drive device according to the present invention are explained in detail.

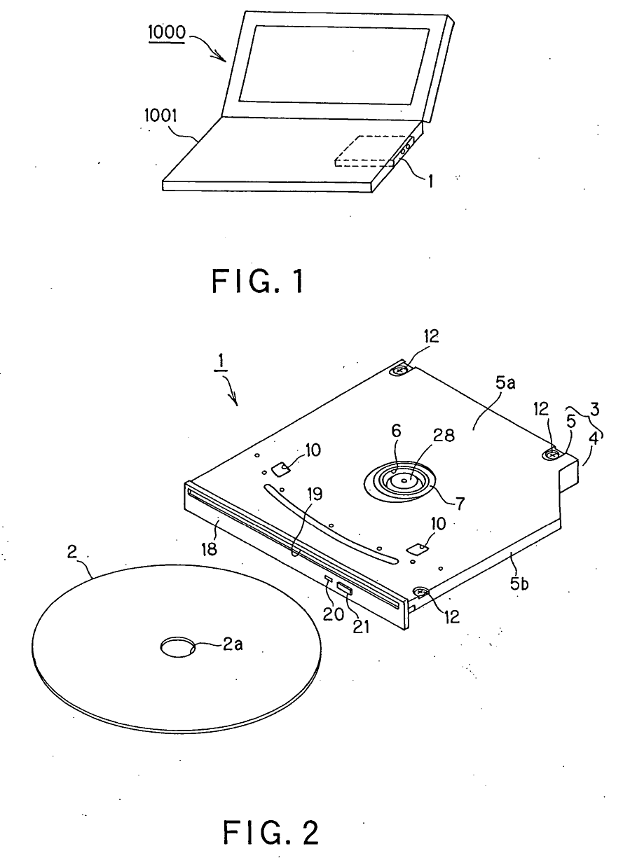

The disc drive device, embodying the present invention, is a slot-in disc driving device 1 loaded on a main body unit 1001 of a notebook personal computer 1000, as shown for example in FIG. 1. This disc driving device 1 has a structure in which the overall device is reduced in thickness up to e.g. 12.5 mm, as shown in FIG. 2, and is able to record and/or reproduce information signals for an optical disc 2, such as a CD (Compact Disk) or DVD (Digital Versatile Disc). This disc driving device 1 is able to cope with a disc 12 cm in diameter, as a standard size, referred to below as a large diameter disc, and with a diameter smaller than that of the large diameter disc, specifically a disc 8 cm in diameter, referred to below as a small diameter disc.

First, a specified structure of the disc driving device 1 includes a casing 3, as an outer casing of the main body unit of the device, as shown in FIG. 2. The casing 3 is made up by a bottom casing 4 in the form of a substantially flat box as a lower casing, and a top cover 5 closing an upper opening of the bottom casing 4.

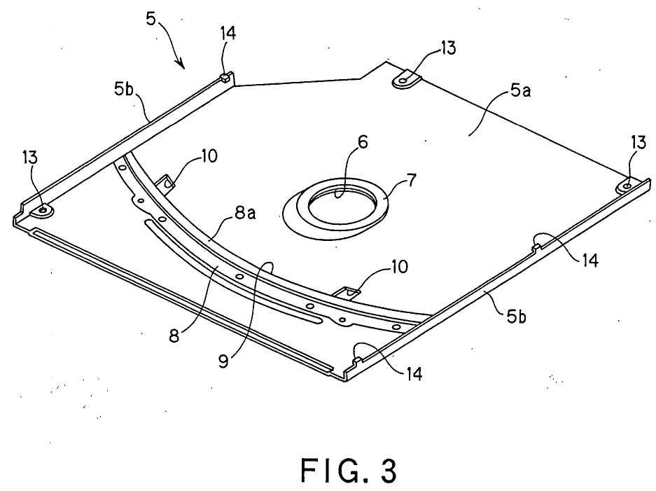

The top cover 5 is formed by a thin metal sheet and includes a top plate part 5a closing the upper opening of the bottom casing 4 and a pair of narrow side plate parts 5b bent at the rim of the top cover 5a along both lateral sides of the bottom casing 4, as shown in FIGS. 2 and 3. The mid part of the top plate part 5a is formed with an approximately circular opening 6. This opening 6 is used for exposing to outside an engagement projection 28a of a turntable 23a, engaged in a center opening 2a of the optical disc 2, at the time of the chuck operation, as later explained. Around the rim of the opening 6 of the top cover 5a is formed an abutment projection 7 slightly protruded towards the inside of the casing 3 into abutment with the rim of the center opening 2a of the optical disc 2.

On the inner major surface of the top plate part 5a is formed a guide member 8 for guiding a distal end of a first rotational arm 35 and a distal end of a second rotational arm 36 in the directions towards and away from each other as the distal end of the first rotational arm 35 and the distal end of the second rotational arm 36 are controlled in the height-wise direction. This guide member 8 is formed by a substantially arcuate-shaped metal sheet extending across both side plate parts 5b of the top plate part 5, and is mounted, such as by spot welding, to a front side of the top cover 5a. The back surface of the guide member 8 includes a step 8a higher in level than the mounting surface on the front side. This forms a guide groove 9, between the top plate part 5a and the step 8a on the back surface of the guide member 8, in which are engaged the distal end of the first rotational arm 35 and the distal end of the second rotational arm 36. In the top plate part 5a are formed work windows 10 for allowing the distal end of the first rotational arm 35 and the distal end of the second rotational arm 36 to be engaged in the guide groove 9.

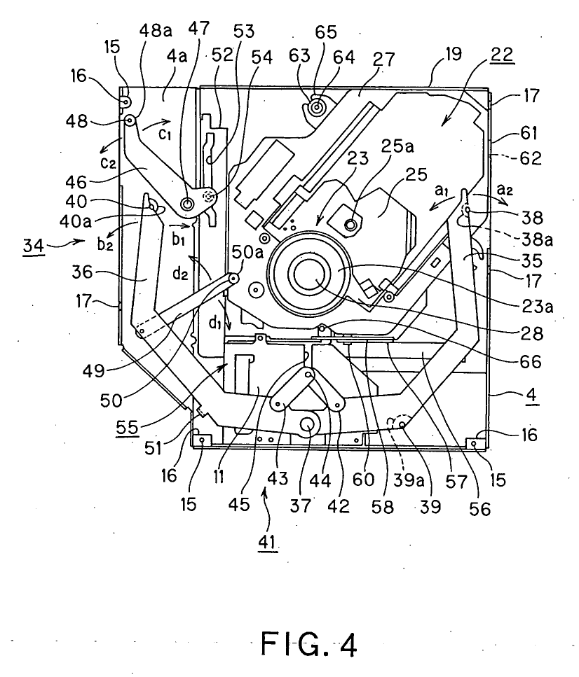

Referring to FIG. 4, the bottom casing 4 is formed by a substantially flat box-shaped metal sheet, the bottom surface of which is substantially rectangular-shaped and a lateral surface of which forms a deck 4a raised to a level higher than the bottom plate part.

On the bottom surface part of the bottom casing 4 are mounted an electronic part, such as an IC chip, forming a driving control circuit, not shown, a connector for electrical connection of various parts, and a detection switch for detecting the operations of various parts. On the bottom surface of the bottom casing 4 is mounted a chassis 11 by a set screw. The chassis 11 is arranged for partitioning the inside of the bottom casing 4 above the circuit substrate into upper and lower sections at approximately the same level as the deck 4a.

The top cover 4 is mounted with a set screw to the bottom casing 5, as shown in FIG. 2. Specifically, plural through-holes 13 for being passed through by set screws are formed in the outer rim of the top plate part 5a, as shown in FIG. 2. A plural number of guide pieces 14 are formed by bending the outer rim part of the bottom casing 4 substantially a right angle towards the inner side. The outer rim of the bottom casing 4 is formed with plural stationary pieces 15 bent at substantially a right angle towards the inner side, as shown in FIG. 4. These stationary pieces 15 are formed with tapped holes 16 in meeting with the through-holes 13 of the top cover 5. In both lateral surface sections of the bottom casing 4 are formed plural guide slits operating for inhibiting disengagement of the plural guide pieces 14 of the top cover 5.

In mounting the top cover 5 on the bottom casing 4, the top cover 5 is slid from the front side towards the back side as the plural guide pieces 14 are engaged in plural guide slits 17 of the top cover 5. Hence, the top plate part 5a of the top cover 5 closes the upper opening of the bottom casing 4. In this state, set screws 12 are threaded into the tapped holes 16 of the bottom casing 4 through the plural through-holes 13 in the top cover 5. This forms the casing 3 shown in FIG. 2.

After assembling, a label seal, not shown, is bonded to the top plate part 5a of the top cover 5 for covering the opening 6 and the work windows 10 in order to prevent dust and dirt from being intruded into the inside of the casing 3.

To the front side of the casing 3 is mounted a substantially rectangular flat-plate-shaped front panel 18, as shown in FIG. 2. In this front panel 18 is formed a disc inserting/ejecting opening 19 for inserting/ejecting the optical disc 2 in the horizontal direction. That is, the optical disc 2 may be introduced into or ejected from the inside of the casing 3 via this disc inserting/ejecting opening 19. On the front surface of the front panel 18, there are provided a display unit 20 for lighting and displaying the access state to the optical disc 2 and an ejection button 21 acted on for ejecting the optical disc 2.

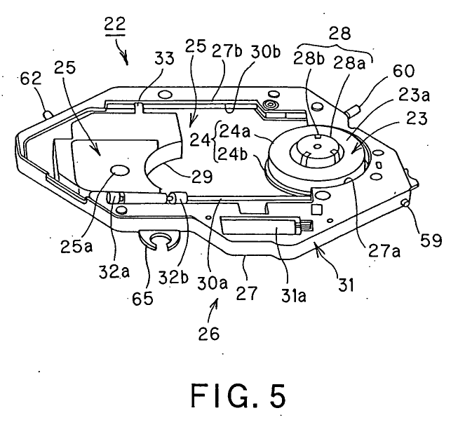

In this disc driving device 1, a base unit 22 forming the main body unit of the device is provided on the bottom surface section of the bottom casing 4, as shown in FIGS. 4 and 5.

This base unit 22 includes a disc loading unit 23, loaded with the optical disc 2 introduced via disc inserting/ejecting opening 19 into the inside of the casing 3, a disc rotating driving unit 24 for rotating and driving the optical disc 2 loaded on the disc loading unit 23, an optical pickup 25 for writing or reading out signals for the optical disc 2, rotationally driven by this disc rotating driving unit 24, and a pickup feed mechanism 26 for feeding the optical pickup 25 along the radius of the optical disc 2. The base unit 22, thus formed, is mounted as one with a base member 27 to form a structure with an ultra thin thickness. This base unit 22 is arranged more forwardly than the chassis 11 in order that the disc loading unit 23 is located at substantially a mid portion on the bottom surface section of the bottom casing 4. The base unit 22 may also be uplifted/lowered by a base lift mechanism 55, as later explained. In the initial state, the base unit 22 is located at a lower location than the optical disc 2 introduced into the inside of the casing 3 through the disc inserting/ejecting opening 19.

The base member 27 is formed by punching a metal sheet to a preset shape and by slightly bending its rim portion downwards. The major surface of the base member 27 is formed with a substantially semicircular aperture for a table 27a for exposing a turntable 23a of the disc loading unit 23 upwards, and a substantially rectangular aperture for the pickup 27b for exposing an objective lens 25a of the optical pickup 25, as later explained, equally upwards, with the aperture for a table 27a being formed in continuation to the aperture for the pickup 27b. A panel, not shown, formed with an opening in register with these apertures 27a, 27b, is mounted to the upper surface part of the base member 27.

The disc loading unit 23 includes a turntable 23a, rotationally driven by the disc rotating driving unit 24. A chuck mechanism 28 for loading the optical disc 2 is provided to the center of the turntable 23a. This chuck mechanism 28 includes an engagement projection 28a, engaged in a center opening 2a of the optical disc 2, and a plural number of retention pawls 28b for retaining the rim of the center opening 2a of the optical disc 2 engaged by the engagement projection 28a, and holds the optical disc 2 on the turntable 23a.

The disc rotating driving unit 24 includes a flat-shaped spindle motor 24a for rotationally driving the optical disc 2 in unison with the turntable 23a. This spindle motor 24a is mounted by set screws to the lower surface of the base member 27 via a support plate 24b so that the turntable 23a provided to its upper surface is slightly protruded from the aperture for the table 27a of the base member 27.

The optical pickup 25 includes an optical block for condensing the light beam radiated from the semiconductor laser as a light source by the objective lens 25a, illuminating a return light beam on the signal recording surface of the optical disc 2, and for detecting the light reflected back from the signal recording surface of the optical disc 2 by a photodetector formed by e.g. a light receiving element, and is designed to write or read out signals on the optical disc 2.

The optical pickup 25 includes an objective lens driving mechanism, such as a biaxial actuator, for displacing and driving the objective lens 25a, in a direction of the optical axis (focusing direction) and in a direction perpendicular to the recording track of the optical disc (tracking direction). Based on detection signals from the optical disc 2, as detected by the photodetector, the optical pickup performs driving control, such as focusing servo of focusing the objective lens 25a on the signal recording surface of the optical disc 2, or the tracking servo of causing the spot of the light beam condensed by the objective lens 25a on the recording track, as the objective lens 25a is displaced in the focusing direction and in the tracking direction by the biaxial actuator. As the objective lens driving mechanism, a triaxial actuator, enabling not only the focusing control and tracking control, but also skew adjustment of adjusting the tilt (skew) of the objective lens 25a relative to the signal recording surface of the optical disc 2 for illuminating the light beam, condensed by the objective lens 25a, on the signal recording surface of the optical direction from a perpendicular direction.

The pickup feed mechanism 26 includes a pickup base 29, loaded with the optical pickup 25, a pair of guide shafts 30a, 30b for supporting the pickup base 29 for sliding in a direction along the radius of the optical disc 2, and a displacement driving mechanism 31 for displacing and driving the pickup base 29, supported by the paired guide shafts 30a, 30b, along the radial direction of the optical disc 2.

The pickup base 29 is provided with a pair of guide pieces 32a, 32b, formed with a guide opening passed through by the guide shaft 30a, out of the paired guide shafts 30a, 30b, and a guide piece 33, formed with a guide groove for receiving the other guide shaft 30b. The guide pieces 32a, 32b and the guide piece 33 are protruded from opposite lateral sides of the pickup base. In this manner, the pickup base 29 is supported for sliding by the paired guide shafts 30a, 30b.

The paired guide shafts 30a, 30b are arranged on the lower surface of the base member 27 in a direction parallel to the radial direction of the optical disc 2, and are designed to guide the pickup base 29, the optical pickup 25 of which is exposed via the aperture for the pickup 27b of the base member 27, across the inner and outer rims of the disc 2.

The displacement driving mechanism 31 transforms the rotational driving of a driving motor 31a, mounted to the base member 27, into a linear movement via a gear or a rack, not shown, for displacing and driving the pickup base 29 in a direction along the paired guide shafts 30a, 30b, that is, in a radial direction of the optical disc 2.

The disc driving device 1 includes a disc transporting mechanism 34 for transporting the optical disc 2 between a disc inserting/ejecting position of inserting/ejecting the optical disc 2 via the disc inserting/ejecting opening 19 and the disc loading position of loading the optical disc 2 on the turntable 23a of the disc loading unit 23, as shown in FIG. 4.

The disc transporting mechanism 34 includes, as support members moved between the major surface of the top plate part 5a facing the disc loading unit 23 and the major surface of the optical disc 2 inserted via the disc inserting/ejecting opening 19, a first rotational arm 35 and a second rotational arm 36, that may be swung within a plane parallel to the major surface of the optical disc 2.

The first rotational arm 35 and the second rotational arm 36 are arranged on left and right sides of the disc loading unit 23. The proximal ends of these first and second rotational arms, located closer to the back surface side than the disc loading unit 23, are carried for rotation, while the distal ends thereof, located closer to the back surface side than the disc loading unit 23, may be swung in a direction towards and away from each other within a plane parallel to the major surface of the optical disc 2.

Specifically, the first rotational arm 35 is formed of an elongated metal sheet and is provided on the left or right side, with the turntable 23a of the disc loading unit 23 in-between, for example, on the right side of FIG. 4, and is carried for rotation in a direction indicated by arrow a₁ or in a direction indicated by arrow a₂, via a first support shaft 37 provided on the chassis 11. On the distal end of the first rotational arm 35, a first forward surface side abutment member 38, designed to be abutted against the outer periphery of the optical disc 2, inserted via the disc inserting/ejecting opening 19, is provided for protruding downwards. A first back surface side abutment member 39, abutted against the outer rim part of the optical disc 2, along with the first forward surface side abutment member 38, when the optical disc 2 is positioned at the disc loading location, is mounted to the vicinity of the proximal end of the first rotational arm 35 for protruding downwards.

The first forward surface side abutment member 38 and the first back surface side abutment member 39 are formed of a resin softer than the optical disc 2. The mid parts of the first forward surface side abutment member 38 and the first back surface side abutment member 39, abutted against the outer rim of the optical disc 2, inserted from the disc inserting/ejecting opening 19, are curved inwards, with both extreme ends thereof being formed as flanged portions 38a, 39a, enlarged in diameter, to present the shape of a drum for inhibiting the movement along the height of the optical disc 2. The first forward surface side abutment member 38 and the first back surface side abutment member 39 may be rolls of small diameter mounted for rotation on the major surface of the first rotational arm 35 facing the disc loading unit 23.

The second rotational arm 36 is formed by an elongated metal sheet located on the other of the left and right sides, for example, on the left side of FIG. 4, on both sides of the turntable 23a of the disc loading unit 23. The proximal end of the second rotational arm 36 is carried for rotation in a direction indicated by arrow b₁ and in a direction indicated by arrow b₂ via the first support shaft 37 provided on the chassis 11. A second forward surface side abutment member 40, abutted against the outer rim of the optical disc 2, inserted via the disc inserting/ejecting opening 19, is provided for protruding downwards.

The second forward surface side abutment member 40 is formed of a resin softer than the optical disc 2. The mid part of the second forward surface side abutment member 40, abutted against the outer rim of the optical disc 2, inserted from the disc inserting/ejecting opening 19, is curved inwards, with both extreme ends thereof being formed as a flanged portion 40a, enlarged in diameter, to present the shape of a drum for inhibiting the movement along the height of the optical disc 2. The second forward surface side abutment member 40 may be a roll of small diameter mounted for rotation on the major surface of the second rotational arm 36 facing the disc loading unit 23.

In this manner, the first rotational arm 35 and the second rotational arm 36 are arranged substantially symmetrically on both sides of the turntable 23a of the disc loading unit 23, with the centers of rotation of the first and second rotational arms being coincident at a mid portion closer to the back side than the disc loading unit 23. The distal ends of the first rotational arm 35 and the second rotational arm 36, engaged in the guide groove 9 of the top plate part 5a, are carried for sliding along the direction of rotation.

The disc transporting mechanism 34 includes an interlock mechanism 41 for interlocking the movements of the first rotational arm 35 and the second rotational arm 36. By this interlock mechanism 41, the first rotational arm 35 and the second rotational arm 36 may be rotated in relatively opposite directions.

Specifically, the interlock mechanism 41 includes a first connecting arm 42 and a second connecting arm 43 interconnecting the first rotational arm 35 and the second rotational arm 36. The first connecting arm 42 and the second connecting arm 43 are formed by elongated metal sheets. One longitudinal ends of the first and second connecting arms are rotatably carried by the proximal ends of the first rotational arm 35 and the second rotational arm 36, while the other longitudinal ends thereof are rotatably carried via a second support shaft 44 according to a so-called pantographic structure. The second support shaft 44 is engaged in a guide slit 45 formed at a location closer to the forward side than the first support shaft 37, this guide slit 45 being formed linearly along the inserting direction of the optical disc 2.

Consequently, the first rotational arm 35 and the second rotational arm 36 may be rotated in relatively opposite directions, via the first connecting arm 42 and the second connecting arm 43, by the second support shaft 44 sliding in a guide slit 45. That is, the distal ends of the first rotational arm 35 and the second rotational arm 36 may be swung by this interlock mechanism 41 in a direction towards and away from each other.

The proximal ends of the first rotational arm 35 and the second rotational arm 36 are provided with torsion coil springs, not shown, operating as biasing means for biasing these rotational arms 35, 36 in a direction approaching to each other.

The disc transporting mechanism 34 includes, as loading assisting means for assisting in the loading operation of retracting the optical disc 2 into the inside of the casing 3, a third rotational arm 46, which may be swung in a plane parallel to the major surface of the optical disc 2 inserted from the disc inserting/ejecting opening 19.

This third rotational arm 46 is formed by an elongated sheet of metal and is positioned at a location closer to the second rotational arm 36 on one of the left and right sides, for example, on the left side in FIG. 4, on both sides of the turntable 23a of the disc loading unit 23. The proximal end of the third rotational arm 46 is carried for rotation in the direction indicated by arrows c₁ and c₂ via a support shaft 47 provided on a deck part 4a. The distal end of the third rotational arm 46 is provided with a third abutment member 48, which may be abutted against the outer rim of the optical disc 2 inserted from the disc inserting/ejecting opening 19, so that the third abutment member 48 will be protruded upwards.

A third abutment member 48 is a small diameter roll mounted for rotation on the major surface facing the top plate part 5a of the third rotational arm 46, and is formed of a resin softer than the optical disc 2. The third abutment member 48 substantially has the shape of a drum, with a center part thereof, abutted against the outer rim of the optical disc 2, introduced via the disc inserting/ejecting opening 19, being bent inwards, and with both ends thereof being enlarged in diameter in the form of a flange 40a, for inhibiting the movement along the height-wise direction of the optical disc 2.

The disc transporting mechanism 34 includes a fourth rotational arm 49, rotatable within a plane parallel to the major surface of the optical disc 2, introduced via the disc inserting/ejecting opening 19, for acting as ejection assisting means for assisting in the operation of ejecting the optical disc 2 via the disc inserting/ejecting opening 19 to outside the casing 3.

A fourth rotational arm 49 is formed by an elongated sheet of metal and is positioned at a mid part of the second rotational arm 36 on one of the left and right sides, for example, on the left side in FIG. 4, on both sides of the turntable 23a of the disc loading unit 23, and is supported for rotation in a direction indicated by arrow d₁ and in a direction indicated by arrow d₂. The distal end of the fourth rotational arm 49 is provided with a fourth abutment member 50, which may be abutted against the back side of the outer rim part of the optical disc 2 inserted from the disc inserting/ejecting opening 19, so that the fourth abutment member 50 will be protruded upwards.

The fourth abutment member 50 is formed of a resin softer than the optical disc 2 and substantially has the shape of a drum, with a center part thereof, abutted against the outer rim of the optical disc 2, introduced via the disc inserting/ejecting opening 19, being bent inwards, and with both ends thereof being enlarged in diameter in the form of a flange 50a, for inhibiting the movement along the height-wise direction of the optical disc 2. The fourth abutment member 50 may also be a small diameter roll mounted for rotation on the major surface facing the top plate part 5a of the fourth rotational arm 49.

The second rotational arm 36 is provided with a rotation inhibiting piece 51 for inhibiting rotation of the fourth rotational arm 49 towards the back side, that is, in the direction indicated by arrow d₁, in case the fourth rotational arm 49 is rotated towards the back side.

The disc transporting mechanism 34 includes a driving lever 52 for effecting concerted operations of the rotational arms 35, 36, 46, 49. This driving lever 52 is formed by a resin member, formed in its entirety by a substantially rectangular-shaped resin member, and is arranged on the bottom side of the bottom casing 4 between one lateral side of the bottom casing 4 and the base unit 22. The driving lever 52 is located at a height level lower than the optical disc 2, and has its upper surface in a height level substantially coincident with the bottom surface of the deck part 4a. This driving lever 52 is slidable in the fore-and-aft direction via a displacement mechanism, not shown, formed by a driving motor provided on the bottom surface of the bottom casing 4 and a set of gears.

In the disc transporting mechanism 34, the aforementioned second support shaft 44 is slid within the guide slit 45 in association operatively with the sliding movement of the driving lever 52. This causes rotation of the first rotational arm 35 and the second rotational arm 36 in relatively opposite directions by the interlock mechanism 41. The proximal end of the third rotational arm 46 is provided with a guide pin 54 engaged in a guide slit 53 formed in the upper surface of the driving lever 52. The third rotational arm 46 performs a swinging movement by a guide pin 54 sliding within the guide slit 53 in association operatively with the sliding of the driving lever 52. The fourth rotational arm 49 is also rotated in association operatively with the sliding of the driving lever 52 via a connection mechanism, not shown.

This disc transporting mechanism 34 executes the loading operation of retracting the optical disc 2 into the inside of the casing 3 via the disc inserting/ejecting opening, the centering operation of positioning the optical disc 2 at the disc loading position, and the ejection operation of ejecting the optical disc 2 to outside the casing 3 through the disc inserting/ejecting opening 19, by concerted operations of the first to fourth rotational arms 35, 36, 46 and 49.

The disc driving device 1 includes a base lift mechanism 55 for lifting the base member 27 in association operatively with the sliding movement of the driving lever 52, as shown in FIG. 4.

The base lift mechanism 55 effects up-and-down movements of the base member 27 between a chuck position in which the base member 27 is uplifted to set the optical disc 2, positioned in the disc mounting position, on the turntable 23a of the disc loading unit 23, a chuck releasing position in which the base member 27 is lowered to detach the optical disc 2 from the turntable 23a of the disc loading unit 23, and an intermediate position in which the base member 27 is set between the chuck position and the chuck releasing position to effect signal recording and/or reproduction for the optical disc 2.

Specifically, there is formed a cam slit, not shown, associated with each of the chuck position, chuck releasing position and the intermediate position, for extending longitudinally along the back surface of the base member 27.

On the bottom surface of the bottom casing 4, a cam lever 56 is formed for extending along the back surface of the base member 27. This cam lever 56 is an elongated flat-plate member, and is slid in a direction substantially perpendicular to the slide direction of the driving lever 52 in association operatively with the sliding along the fore-and-aft direction of the driving lever 52. The mid part of the cam lever 56 is provided with a cam piece 57 bent upwards from an edge of the cam lever facing the base member 27. In the cam piece 57, there are formed longitudinally extending cam slits, not shown, associated with the chuck position, chuck releasing position and the intermediate position.

The bottom surface of the bottom casing 4 is formed with a bent piece 58 for extending along the lateral surface of the base member 27. In this bent piece 58 is bored a vertically extending slit, not shown, for allowing the up-and-down movement of the base member 27.

Referring to FIG. 5, the base member 27 includes a first support shaft 59, engaged in and carried by a cam slit of the driving lever 52. The first support shaft 59 is located towards the disc loading unit 23 on the lateral surface of the base member 27 facing the driving lever 52. The base member 27 also includes a second support shaft 60, engaged in and carried by a cam slit of a cam piece 57 and in a vertically extending slit of the bent piece 58. The second support shaft 60 is located towards the disc loading unit 23 on the lateral surface of the base member 27 facing the driving lever 56. The base member 27 also includes a third support shaft 62 located on the front side of the base member opposite to the driving lever 52. The third support shaft is rotationally carried in a shaft opening 61 formed in the opposite lateral side of the bottom casing 4. The base member 27 also includes a fixed support 65 secured, such as by a set screw 64, to the bottom surface of the bottom casing 4 via an insulator 63, formed of a visco-elastic member e.g. of rubber. The fixed support 65 is located towards the front side of the base member opposite to the lateral side thereof facing the am lever 56.

Thus, in this base lift mechanism 55, the side towards the disc loading unit 23 of the base member 27 performs an up-and-down movement, relative to the front surface side, between the chuck position, chuck releasing position and the intermediate position, by the first support shaft 59 sliding in the cam slit of the driving lever 52, and by the second support shaft 60 sliding in the cam slit of the cam lever 56 and in the vertically extending slit in the bent piece 58, in association operatively with the sliding of the driving lever 52 and the cam lever 56.

Referring to FIG. 4, a hoist pin 66, as chuck releasing means for releasing the optical disc 2, loaded on the turntable 23a of the disc loading unit 23, from the turntable 23a, when the base member 27 is lowered by the base lift mechanism 55, is provided on the bottom surface section of the bottom casing 4. This hoist pin 66 is provided on the back surface side of the base member 27 in the vicinity of the disc loading unit 23 of the base unit 22, specifically, on a back surface part closest to the disc loading unit 23, for protruding upwards from the bottom surface section of the bottom casing 4.

The specified operation of the disc driving device 1, described above, is now explained.

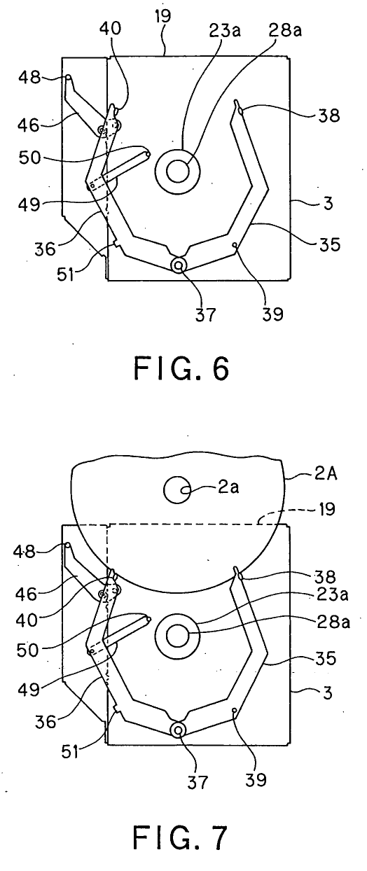

In the disc driving device 1, the first rotational arm 35 and the second rotational arm 36 are held with the respective distal ends opened to a preset opening angle, in the initial state prior to insertion of the optical disc 2, as shown in FIG. 6. A third rotational arm 46 is held in such a state in which its distal end is located more outwards and more forwardly than its proximal end. A fourth rotational arm 49 is held in such a state in which its distal end is located more inwards and more forwardly than its proximal end. The fourth rotational arm is provided on the front surface side of the bottom casing 4.

With the present disc driving device 1, optical discs 2A, 2B of different diameters, introduced via the disc inserting/ejecting opening 19 of the casing 3, may be retracted up to the disc loading position, by way of disc loading.

Specifically, when the large diameter disc 2A has been introduced via disc inserting/ejecting opening 19 of the casing 3, the back surface side of the outer rim of the large diameter disc 2A, introduced via disc inserting/ejecting opening 19 into the inside of the casing 3, is abutted against the first forward surface side abutment member 38 of the first rotational arm 35 and against the second forward surface side abutment member 40 of the second rotational arm 36.

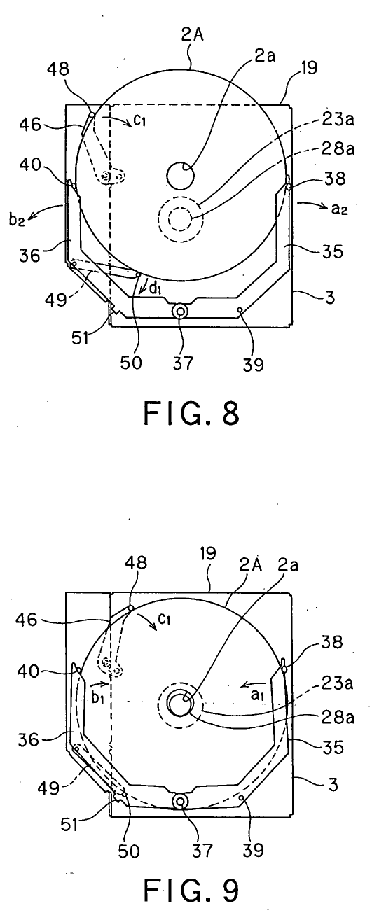

In case the large diameter disc 2A is further intruded via disc inserting/ejecting opening 19 into the inside of the casing 3, the outer rim of the large diameter disc 2A is sandwiched between the first forward surface side abutment member 38 and the second forward surface side abutment member 40, as shown in FIG. 8. In this case, the first rotational arm 35 and the second rotational arm 36 are rotated in a direction away from each other, that is, in a direction indicated by arrow a₂ and in a direction indicated by arrow b₂ in FIG. 8, against the bias of the torsion coil springs, not shown, as the first forward surface side abutment member 38 and the second forward surface side abutment member 40 are abutted against the back side of the outer rim of the large diameter disc 2A.

When the first rotational arm 35 and the second rotational arm 36 have been rotated by preset amounts in the direction away from each other, a detection switch, provided on the circuit substrate, is thrust to slide the driving lever 52 towards the back side by a displacement driving mechanism.

This causes the third rotational arm 46 to be rotated in the direction of the arrow c, shown in FIG. 8. On the other hand, since the third rotational arm 46 is abutted against the front side of the outer rim of the large diameter disc 2A, the large diameter disc 2A is retracted into the inside of the casing 3, as the third rotational arm 46 thrusts the forward surface side of the outer rim part of the large diameter disc 2A.

If the large diameter disc 2A is retracted into the inside of the casing 3, until the center opening 2a of the large diameter disc 2A is located towards the back surface side beyond a straight line interconnecting the first forward surface side abutment member 38 and the second forward surface side abutment member 40, the first forward surface side abutment member 38 and the second forward surface side abutment member 40 are turned around from the back surface side towards the front surface side, around the outer rim of the large diameter disc 2A, as shown in FIG. 9. Then, with the forward surface side abutment member 38 and the second forward surface side abutment member 40 abutting against the front surface side of the outer rim of the large diameter disc 2A, the first rotational arm 35 and the second rotational arm 36 are rotated in a direction towards each other, that is, in the directions indicated by arrows a₁ and b₁ in FIG. 9, under the bias of the torsion coil springs, not shown.

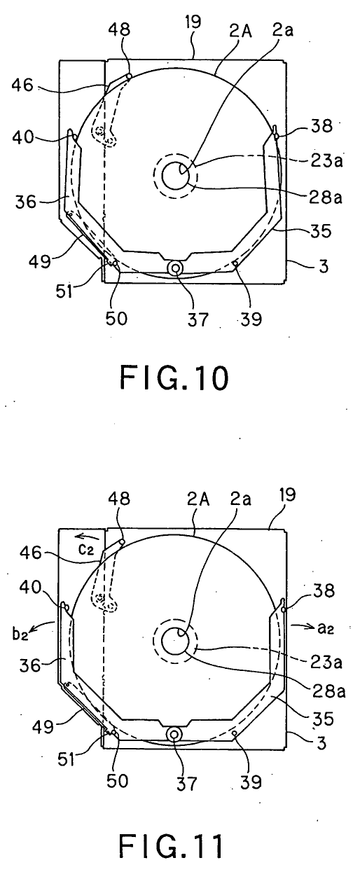

In this manner, the large diameter disc 2A is retracted up to the disc loading position, shown in FIG. 10, as the first rotational arm 35 and the second rotational arm 36 thrust the front surface side of the outer rim of the large diameter disc 2A.

On the other hand, the fourth rotational arm 49 is rotated in the direction indicated by arrow d₁ in FIG. 9, by the fourth abutment member 50 abutting against and thrust by the back surface side of the outer rim of the large diameter disc 2A. When the large diameter disc 2A has been retracted into the disc loading position, shown in FIG. 10, the fourth rotational arm 49 is abutted against an inhibiting member 51 of the second rotational arm 36 and hence is restrained from rotation.

If the small diameter disc 2B is inserted via disc inserting/ejecting opening 19, the back surface side of the small diameter disc 2B, inserted via disc inserting/ejecting opening 19 into the inside of the casing 3, is abutted against the first forward surface side abutment member 38 of the first rotational arm 35 and the second forward surface side abutment member 40 of the second rotational arm 36.

If the small diameter disc 2B is further intruded from this state via disc inserting/ejecting opening 19 into the inside of the casing 3, as shown in FIG. 17, the outer rim of the large diameter disc 2A is sandwiched between the first forward surface side abutment member 38 and the second forward surface side abutment member 40. In this case, the first rotational arm 35 and the second rotational arm 36 are rotated in a direction away from each other, that is, in a direction indicated by arrow a₂ and in a direction indicated by arrow b₂ in FIG. 17, against the bias of the torsion coil springs, not shown, as the first forward surface side abutment member 38 and the second forward surface side abutment member 40 are abutted against the back side of the outer rim of the small diameter disc 2B.

When the first rotational arm 35 and the second rotational arm 36 have been rotated by preset amounts in the direction away from each other, a detection switch, provided on the circuit substrate, is thrust by a displacement driving mechanism to slide the driving lever 52 towards the back side.

This causes the third rotational arm 46 to be rotated in the direction of the arrow c₁ shown in FIG. 17. On the other hand, since the third rotational arm 46 is abutted against the front side of the outer rim of the small diameter disc 2B, the small diameter disc 2B is retracted through the disc inserting/ejecting opening 19 into the inside of the casing 3, as the third rotational arm 46 thrusts the forward surface side of the outer rim part of the small diameter disc 2B.

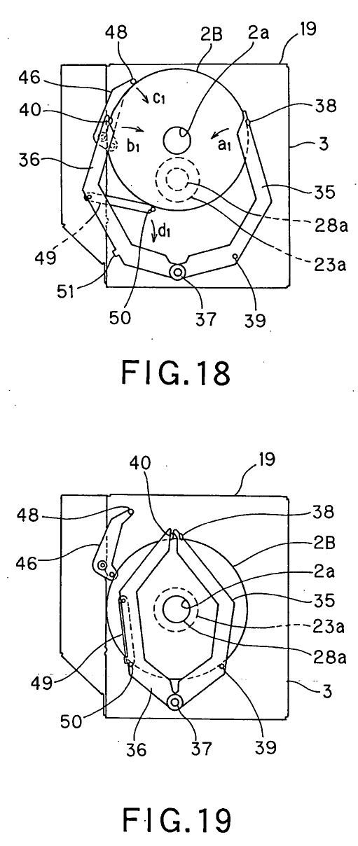

If the small diameter disc 2B is retracted into the inside of the casing 3, until the center opening 2a of the small diameter disc 2B is located towards the back surface side beyond a straight line interconnecting the first forward surface side abutment member 38 and the second forward surface side abutment member 40, the first forward surface side abutment member 38 and the second forward surface side abutment member 40 are turned around from the back surface side towards the front surface side, around the outer rim of the small diameter disc 2B, as shown in FIG. 18. Then, with the forward surface side abutment member 38 and the second forward surface side abutment member 40 abutting against the front surface side of the outer rim of the small diameter disc 2B, the first rotational arm 35 and the second rotational arm 36 are rotated in a direction towards each other, that is, in the directions indicated by arrows a₁ and b₁ in FIG. 18, under the bias of the torsion coil springs, not shown.

In this manner, the small diameter disc 2B is retracted up to the disc loading position, shown in FIG. 19, as the first rotational arm 35 and the second rotational arm 36 thrust the front surface side of the outer rim of the small diameter disc 2B.

On the other hand, the fourth rotational arm 49 is rotated in the direction indicated by arrow d₁ in FIG. 18, by the fourth abutment member 50 abutting against and thrust by the back surface side of the outer rim of the small diameter disc 2B. When the small diameter disc 2B has been retracted into the disc loading position, shown in FIG. 19, the fourth rotational arm 49 is abutted against an inhibiting member 51 of the second rotational arm 36 and hence is restrained from rotation.

With the present disc driving device 1, in case the optical discs 2A, 2B with differing outer diameters have been retracted up to the disc loading position, by the first rotational arm 35 and the second rotational arm 36, the optical discs 2A, 2B are sandwiched on the inner sides of the first forward surface side abutment member 38, first back surface side abutment member 39, second forward surface side abutment member 40 and the fourth abutment member 50, for positioning the optical discs 2A, 2B with differing outer diameters in the disc loading position, by way of centering. That is, the center openings 2a of the optical discs 2A, 2B with differing outer diameters are brought into coincidence with the engagement projection 28a of the turntable 23a in a direction perpendicular to the major surface of the optical disc 2.

With the present disc driving device 1, after the centering operation for the optical disc 2, described above, the base lift mechanism 55 uplifts the base member 27, in order to perform the chuck operation of loading the optical disc 2, located at the disc loading position, on the turntable 23a of the disc loading unit 23.

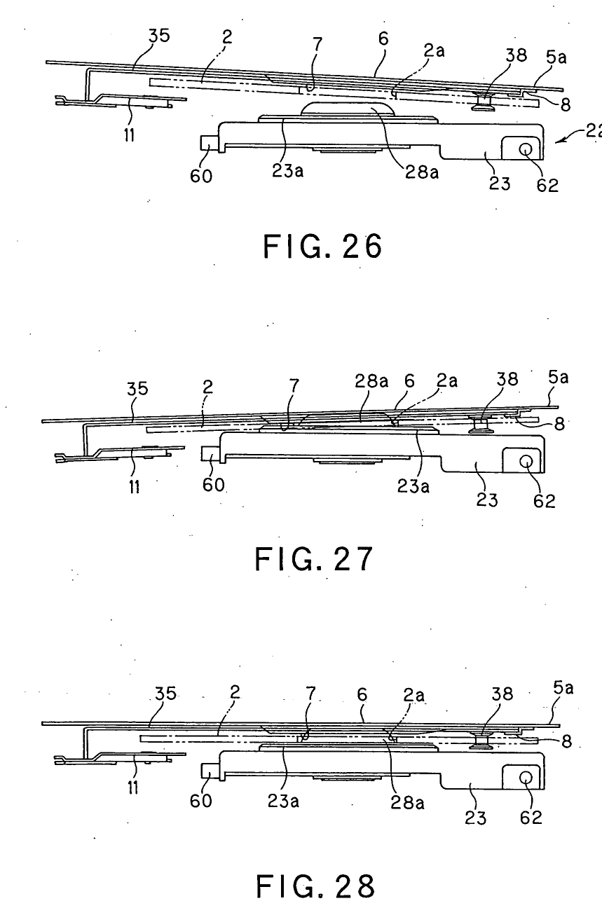

Specifically, when the base member 27 is uplifted by the base lift mechanism 55 from the chuck releasing position shown in FIG. 26 to the chuck position shown in FIG. 27, the rim part of the center opening 2a of the optical disc 2 is thrust against the abutment projection 7 of the top plate part 5a, as the engagement projection 28a is introduced into the center opening 2a of the optical disc 2, at the same time as the optical disc 2 is held on the turntable 23a, with plural retention pawls 28b engaging with the rim of the center opening 2a of the optical disc 2. With the optical disc 2 held on the turntable 23a, the base 27 is lowered to the intermediate position shown in FIG. 28.

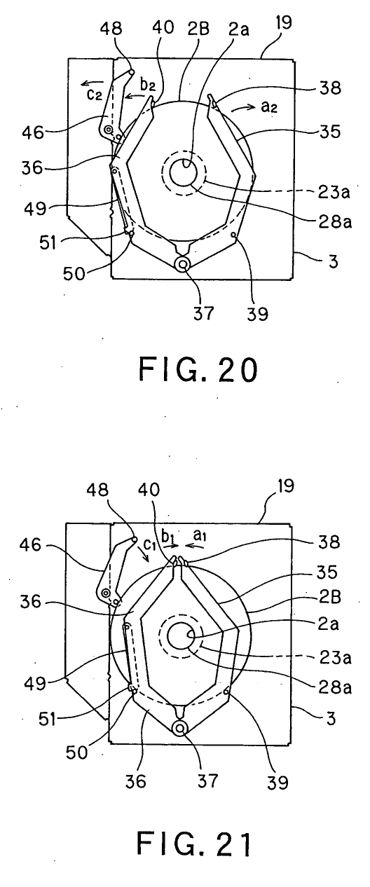

With the present disc driving device 1, the first rotational arm 35 and the second rotational arm 36 are slightly rotated, after the above-described chuck operation, in association operatively with the sliding towards the back side of the driving lever 52, in a direction in which the two arms are moved away from each other, that is, in the directions indicated by arrows a₂, b₂ in FIGS. 11 and 20. At this time, the fourth rotational arm 49 is rotated in unison with the second rotational arm 36, as the fourth rotational arm is abutted against the rotation inhibiting piece 51. Also, the third rotational arm 46 is slightly rotated in a direction indicated by an arrow c₂ in FIGS. 11 and 20, in association operatively with the slide movement towards the back side of the driving lever 52.

Hence, the first forward surface side abutment member 38, first back surface side abutment member 39, second forward surface side abutment member 40, third abutment member 48 and the fourth abutment member 50 are spaced apart from the outer rim of the optical discs 2A, 2B held on the turntable 23a.

If, with the present disc driving device 1, a command for recording or reproduction is sent from the personal computer 1000, from the state shown in FIGS. 11, 20 and 28, information signals are recorded or reproduced for the optical disc 2, based on this command. Specifically, the spindle motor 24a rotationally drives the optical disc 2, in unison with the turntable 23a, at the same time as the optical pickup 25 is moved from the outer rim part towards the inner rim part by the pickup feed mechanism 26 and focusing servo as well as tracking servo is applied. This enables TOC data, recorded in the lead-in area of the optical disc 2, to be read out. If then the information signals are to be recorded, the optical pickup 25 is moved to a preset address in a program area of the optical disc 2, based on the read-out TOC data. In reproducing the information signals, the optical pickup 25 is moved to an address in the program area where there are recorded specified data. This optical pickup 25 writes/reads out information signals for a desired recording track of the optical disc 2.

If, with the present disc driving device 1, the ejection button 21, provided on the front panel 20, is thrust, or if an eject command is sent from the personal computer 1000 to the disc driving device 1, the driving lever 52 commences to be slid towards the front side by the displacement mechanism.

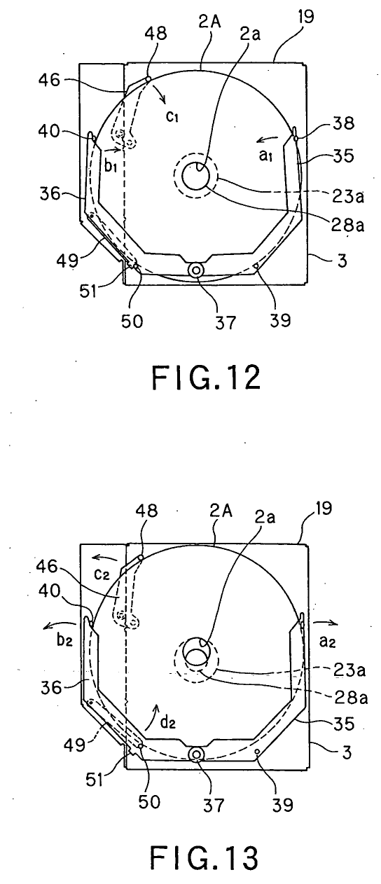

The first rotational arm 35 and the second rotational arm 36 are then slightly rotated, in association operatively with the sliding towards the front surface of the driving lever 52, in a direction in which the first rotational arm 35 and the second rotational arm 36 are moved towards each other, that is, in a direction of arrows a₁, b₁ in FIGS. 12 and 21. At this time, the fourth rotational arm 49 is rotated in unison with the second rotational arm 36, as the rotation inhibiting piece 51 is abutted against the fourth rotational arm 49. The third rotational arm 46 is slightly rotated in the direction indicated by arrow c₁ in FIGS. 12 and 21.

In this manner, the first forward surface side abutment member 38, first back surface side abutment member 39, second forward surface side abutment member 40, abutment member 48 and the fourth abutment member 50 are abutted against the outer rim parts of the optical discs 2A, 2B held on the turntable 23a. In the case of the small diameter disc 2B, shown in FIG. 21, the fourth abutment member 50 is spaced apart from the outer rim of the small diameter disc 2B.

With the present disc driving device 1, the base lift mechanism 55 lowers the base member 27 to the chuck releasing position to disengage the optical disc 2 from the turntable 23a of the disc loading unit 23, by way of performing the chuck releasing operation.

Specifically, when the base member 27 is lowered to the chuck releasing position, the distal end of the hoist pin 66 is abutted against the signal non-recording area on the inner rim side of the optical disc 2 loaded on the turntable 23a of the disc loading unit 23 to uplift the optical disc 2 to release the disc from the turntable 23a.

With the present disc driving device 1, the optical discs 2A, 2B on the disc loading unit 23 are ejected from the disc inserting/ejecting opening 19 to outside the casing 3.

Specifically, when the large diameter disc 2A is ejected via the disc inserting/ejecting opening 19 of the casing 3, the fourth rotational arm 49 is rotated in the direction indicated by arrow d₂ in FIG. 13 in association operatively with the sliding towards the front side of the driving lever 52. Since the fourth abutment member 50 is abutted against the back side of the outer rim part of the large diameter disc 2A, the fourth rotational arm 49 thrusts the back surface of the outer rim part of the large diameter disc 2A to thrust the large diameter disc 2A to outside the casing 3.

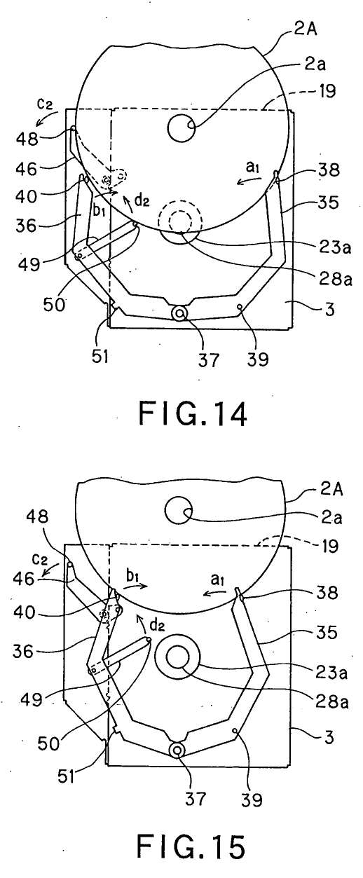

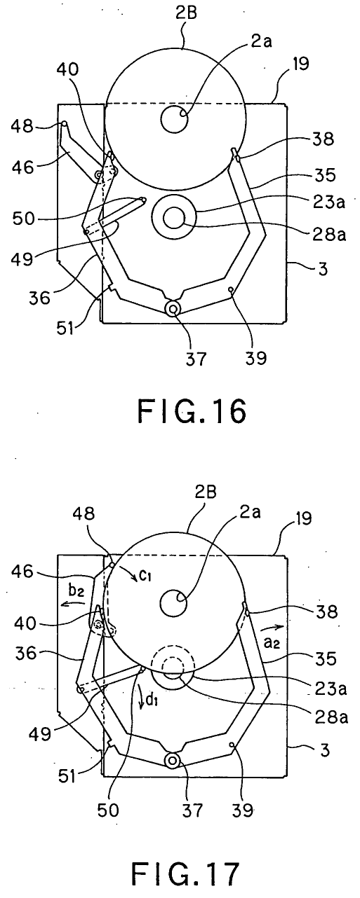

If the large diameter disc 2A is ejected to outside of the casing 3, until the center opening 2a of the large diameter disc 2A is located towards the front surface side beyond a straight line interconnecting the first forward surface side abutment member 38 and the second forward surface side abutment member 40, the first forward surface side abutment member 38 and the second forward surface side abutment member 40 are turned around from the front surface side towards the back surface side, around the outer rim of the large diameter disc 2A, as shown in FIG. 14. Then, with the forward surface side abutment member 38 and the second forward surface side abutment member 40 abutting against the back surface side of the outer rim of the large diameter disc 2A, the first rotational arm 35 and the second rotational arm 36 are rotated in a direction towards each other, that is, in the directions indicated by arrows a₁ and b₁ in FIG. 14, under the bias of the torsion coil springs, not shown.

The third rotational arm 46 is rotated in the direction indicated by arrow c₂ in FIG. 14, by the third abutment member 48 being thrust by abutment against the outer rim of the large diameter disc 2A.

The first rotational arm 35 and the second rotational arm 36, thrusting the back surface side of the outer rim of the large diameter disc 2A, protrudes the large diameter disc 2A to the disc loading/ejecting position shown in FIG. 15, that is, to a position in which the center opening 2a is exposed to outside the casing 3 via the disc inserting/ejecting opening 19.

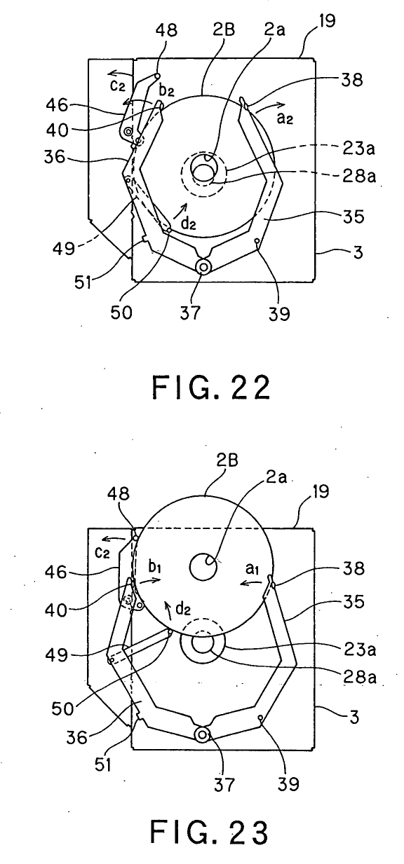

In ejecting the small diameter disc 2B from the disc inserting/ejecting opening 19 of the casing 3, the fourth rotational arm 49 is rotated in the direction indicated by arrow d₂ shown in FIG. 22, as shown in FIG. 22, in association operatively with the sliding towards the front side of the driving lever 52. Since the fourth abutment member 50 is abutted against the back side of the outer rim part of the small diameter disc 2B, the fourth rotational arm 49 thrusts the back surface of the outer rim part of the small diameter disc 2B to thrust the small diameter disc 2B to outside the casing 3.

If the small diameter disc 2B is ejected to outside of the casing 3, until the center opening 2a of the small diameter disc 2B is located towards the front surface side beyond a straight line interconnecting the first forward surface side abutment member 38 and the second forward surface side abutment member 40, the first forward surface side abutment member 38 and the second forward surface side abutment member 40 are turned around from the front surface side towards the back surface side, around the outer rim of the small diameter disc 2B, as shown in FIG. 23. Then, with the forward surface side abutment member 38 and the second forward surface side abutment member 40 abutting against the back surface side of the outer rim of the small diameter disc 2B, the first rotational arm 35 and the second rotational arm 36 are rotated in a direction towards each other, that is, in the directions indicated by arrows a₁ and b₁ in FIG. 23, under the bias of the torsion coil springs, not shown.

The third rotational arm 46 is rotated in the direction indicated by arrow c2 in FIG. 23, by the third abutment member 48 being thrust by abutment against the outer rim of the small diameter disc 2B.

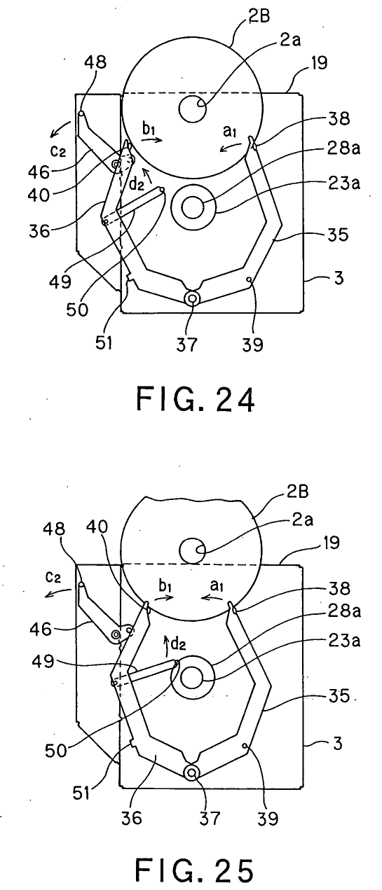

The first rotational arm 35 and the second rotational arm 36, thrusting the back surface side of the outer rim of the small diameter disc 2B, extrudes the small diameter disc 2B to the disc inserting/ejecting position shown in FIG. 24.

In the case of the small diameter disc 2B, the small diameter disc 2B can be extruded up to the position where the center opening 2a of the small diameter disc 2B is exposed to outside the casing 3 through the disc inserting/ejecting opening 19, by rotating the first rotational arm 35 and the second rotational arm 36 further in a direction approaching to each other, that is, in the directions indicated by arrows a₁ and b₁ in FIG. 25.

With the present disc driving device 1, the optical discs 2A, 2B with different diameters may be positioned in the disc loading position, by way of centering, by having the optical discs 2A, 2B sandwiched on the inner sides of the first forward surface side abutment member 38, first back surface side abutment member 39, second forward surface side abutment member 40 and the fourth abutment member 50, when the optical discs 2A, 2B with different diameters have been retracted up to the disc loading position by the first rotational arm 35 and the second rotational arm 36.

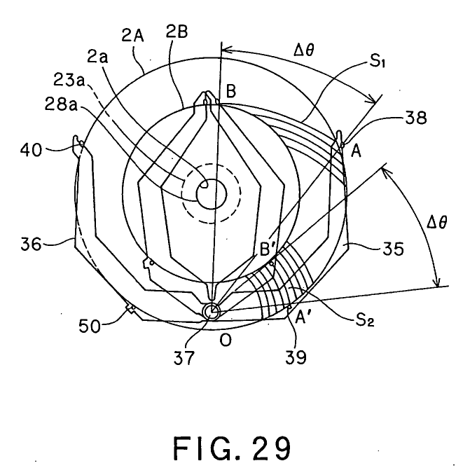

The first rotational arm 35 and the second rotational arm 36 are arranged substantially symmetrically on both sides of the turntable 23a of the disc loading unit 23, such that the first rotational arm 35 and the second rotational arm 36 may be rotated in a direction towards and away from each other, about the center of rotation O, located more rearwardly than the turntable 23a, as shown schematically in FIG. 29.

Out of the four abutment members, that is, the first forward surface side abutment member 38, first back surface side abutment member 39, second forward surface side abutment member 40, and the fourth abutment member 50, the first forward surface side abutment member 38 of the first rotational arm 35, located closer to the front surface side than the turntable 23a, and the first back surface side abutment member 39 of the first rotational arm 35, located closer to the back surface side than the turntable 23a, on one hand, and the second forward surface side abutment member 40 of the second rotational arm 36, located closer to the front surface side than the turntable 23a, and the fourth abutment member 50 of the second rotational arm 36, located closer to the front surface side than the turntable 23a, are arranged substantially symmetrically on both sides of a centerline extending along the direction of insertion of the optical disc 2 passing through the center part and the center of rotation O of the turntable 23a.

It is noted that an angular difference Δθ is produced in the ranges of rotation of the first rotational arm 35 and the second rotational arm 36, centered about the center of rotation O, in case of centering the large diameter disc 2A with a diameter of 12 cm and in case of centering the small diameter disc 2B with a diameter of 8 cm.

Hence, by setting the arrangement of the four abutment members, 38, 39, 40 and 50 in advance, in consideration of the angular difference Δθ, it becomes possible to have these four abutment members, 38, 39, 40 and 50 abutted against the outer rim parts of the optical discs 2A, 2B with different diameters at the time of the aforementioned centering operations.

Specifically, when an arc of a circle passing through a point closer to the front surface side than the turntable 23a is S₁, the points of contact of the arc of the circle S₁ and the outer rim parts of the large diameter disc 2A and the small diameter disc 2B at the disc loading positions are A and B, respectively, an arc of a circle passing through a point closer to the back surface side than the turntable 23a is S₂, with S₁>S₂, and the points of contact of the arc of the circle S₂ and the outer rim parts of the large diameter disc 2A and the small diameter disc 2B at the disc loading positions are A′ and B′, respectively, the two arcs of circles S₁ and S₂, which satisfy the relationship of angle AOB=A′OB′=Δθ, are present over a preset radius range. The four abutment members, 38, 39, 40 and 50 are designed to be arranged to be positioned in the locations which satisfy this relationship.

In the vicinity of the arc of a circle S₁, the smaller the radius, the smaller becomes Δθ, and the larger the radius, the larger becomes Δθ. The point where the arc of a circle S₁ is slightly surpassed, that is, the point where the outer rim part of the small diameter disc 2B can hardly be contacted, represents the designing limit. On the other hand, in the vicinity of the arc of a circle S₂, the smaller the radius, the larger becomes Δθ, and the larger the radius, the smaller becomes Δθ. This Δθ has a locally minimum value which represents the designing limit.

In the actual designing, the values of the radii S₁ and S₂, and the angular difference Δθ, most preferred within the gamut of the degrees of the designing freedom, are set. These may readily be found as a drawing is formulated using e.g. the CAD software.

Thus, with the present disc driving device 1, when the optical discs 2A, 2B with different outside diameters are sandwiched on the inner sides of the first forward surface side abutment member 38, first back surface side abutment member 39, second forward surface side abutment member 40 and the fourth abutment member 50 by the first rotational arm 35 and the second rotational arm 36, the center parts (center openings 2a) of these optical discs 2A, 2B with different outside diameters may be made to coincide with the center part of the disc loading unit 23 (engagement projection 28a of the turntable 23a) in a direction perpendicular to the major surface of the optical disc 2. That is, the optical discs 2A, 2B with different outside diameters may be set in the disc loading position correctly in stability, by way of centering.

In this disc driving device 1, the optical discs 2A, 2B with different outside diameters may be retracted by the first rotational arm 35 and the second rotational arm 36 up to the disc loading position and centered simultaneously. That is, the centering operation by the first rotational arm 35 and the second rotational arm 36 simultaneously further retracts the optical disc 2, retracted by the third rotational arm 46, up to the disc loading position.

Thus, with the disc driving device 1, the loading operation of retracting the optical discs 2A, 2B with different outside diameters up to the loading position may be carried out correctly in stability without regard to the difference in the outer diameter of the optical discs 2A, 2B introduced via the disc inserting/ejecting opening 19.

Specifically, the radius of the large diameter disc 2A is 6 cm, while that of the small diameter disc 2B is 4 cm, and hence the distance up to the disc loading position is not equal unless the small diameter disc 2B is pushed via the disc inserting/ejecting opening 19 into the inside of the casing 3 by about 2 cm further than the large diameter disc 2A. That is, the stroke of the small diameter disc 2B up to the disc loading position is shorter by about 2 cm than that of the large diameter disc 2A.

Thus, with the disc driving device 1, the small diameter disc 2B is pushed into the inside of the casing 3 until the center opening 2a of the small diameter disc 2B is located closer to the back surface side than a straight line interconnecting the first forward surface side abutment member 38 and the second forward surface side abutment member 40, by the third rotational arm 46, in order to take up the stroke difference brought about by the difference in the outer diameter of the large diameter disc 2A and the small diameter disc 2B. Meanwhile, if the small diameter disc is pushed by about 10 mm further into the inside of the casing 3, by way of an actual margin, the ensuing retraction operation may be higher in stability.

The small diameter disc 2B, sandwiched between the first forward surface side abutment member 38 and the second forward surface side abutment member 40, may then be retracted up to the disc loading position by the rotation of the first rotational arm 35 and the second rotational arm 36 in the direction of approaching to each other under the bias of the torsion coil springs.

In this case, the difference in the stroke caused by the difference in outer diameter of the large diameter disc 2A and the small diameter disc 2B may be taken up depending on the degree of closure of the first rotational arm 35 and the second rotational arm 36. This positively retracts the optical discs 2A, 2B, different in outer diameter, up to the disc loading position.

In the above disc driving device 1, the third abutment member 48 of the third rotational arm 46 also is designed to be abutted against the outer rim of the large diameter disc 2A at the time of the centering operation of the large diameter disc 2A. That is, a sum of five abutment members, namely the abutment members 38, 39, 40, 48 and 50 are abutted against the outer rim of the large diameter disc 2A.

It is noted that a sum of three or more abutments against the outer rim part of the optical disc 2 at the time of the centering operation are required at at least three locations, encircling the turntable 23a, out of four locations, namely a location closer to the forward side of the first rotational arm 35 than the turntable 23a, a location closer to the back side of the first rotational arm 35 than the turntable 23a, a location closer to the forward side of the second rotational arm 36 than the turntable 23a, and a location closer to the back side of the second rotational arm 36 than the turntable 23a.

Thus, with the above disc driving device 1, the above-described configuration is merely illustrative, such that it is possible to use the configuration in which the third abutment member 48 is spaced apart from the outer rim of the large diameter disc 2A, or in which there are provided three abutment locations, at the time of the centering operation.

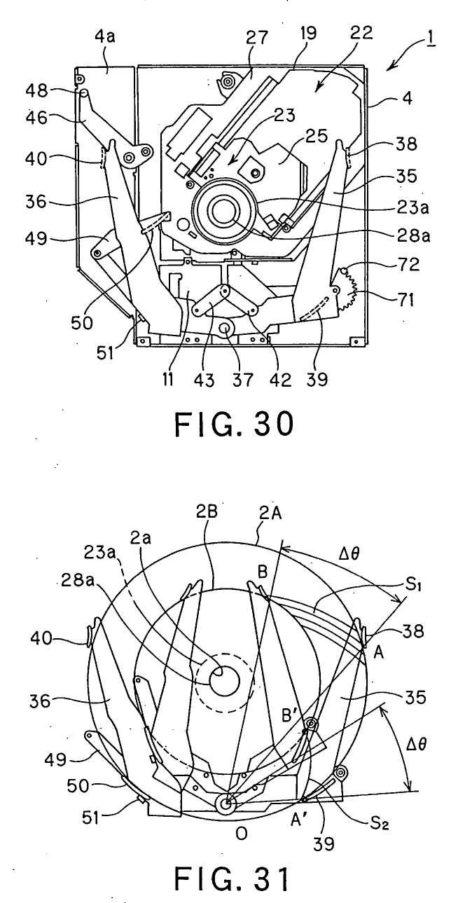

Moreover, with the above disc driving device 1, the abutments 38, 39, 40 and 50, thrust against the outer rim part of the optical disc 2 during centering, may be substantially arcuate in profile, as in the first modification shown in FIG. 30. The radius of the arc is preferably smaller than the radius of the large diameter disc 2A.

In this case, the loading start position by the first rotational arm 35 and the second rotational arm 36 may be on the short side, while the amount of ejection of the optical disc 2 from the disc inserting/ejecting opening 19 after the end of the eject operation may be increased.

Moreover, in this case, the outer rim of the large diameter disc 2A is abutted against the substantially arcuate-shaped back sides of the first back surface side abutment member 39 and the fourth abutment member 50 (point A′ shown in FIG. 31) as shown schematically in FIG. 31. On the other hand, in centering the small diameter disc 2B, the outer rim of the small diameter disc 2B is abutted against the substantially arcuate-shaped front sides of the first back surface side abutment member 39 and the fourth abutment member 50 (point B′ shown in FIG. 31).

Hence, A′OB′=Δθ becomes smaller the longer the length of the arcuate portions of the first back surface side abutment member 39 and the fourth abutment member 50. Moreover, in case the angular difference Δθ becomes smaller, the range of rotation of the first rotational arm 35 and the second rotational arm 36 becomes narrower. As a result, the dead space may be decreased with advantage due to decrease in the traversed portions of the rotational arms 35, 36, while the mechanical stress may also be decreased with advantage by the decrease in the driving stroke of the driving lever 52 driving these rotational arms 35, 36.

By the substantially arcuate profile of the first back surface side abutment member 39 and the fourth abutment member 50, the setting range of the angular difference Δθ may be broader, thus enabling the degree of designing freedom to be increased further.

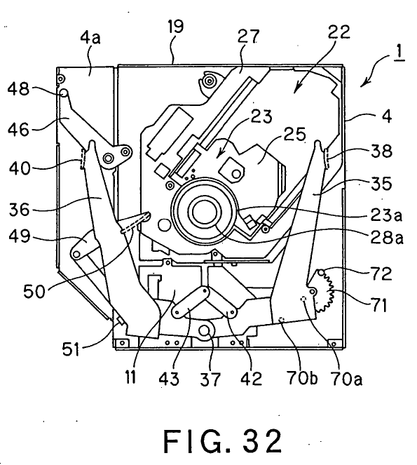

In the above disc driving device 1, plural abutment members may be arranged at the respective abutment locations against the outer rim of the optical disc 2, during centering, as in a second modification shown for example in FIG. 32. In this case, an abutment member 70a, that may be abutted against the outer rim of the large diameter disc 2A, and an abutment member 70b, that may be abutted against the outer rim of the small diameter disc 2B, are arranged closer to the back surface side of the first rotational arm 35 than the turntable 23a, in place of the first back surface side abutment member 39.

It may be contemplated to divide the fourth abutment member 50 into plural abutment sections. However, the fourth abutment member 50 is actuated for movement along the outer rim of the optical disc 2, at the time of the aforementioned loading or ejection operations, and hence is desirably in a substantially arcuate shape, presenting shape continuum, in order to prevent discontinuous operations of the fourth rotational arm 49 formed by plural divided abutment sections.

By way of an ejection assisting means for assisting in the eject operation of the optical disc 2, a fifth rotational member 71, that may be swung in a plane parallel to the major surface of the optical disc 2 introduced via disc inserting/ejecting opening 19, provided for rotation to the first rotational arm 35, may be used, as shown in FIGS. 30 and 32. The fifth rotational member 71 is provided with a fifth abutment member 72 for extending upwards into abutment against the back surface side of the outer rim of the optical disc 2 introduced via the disc inserting/ejecting opening 19. This assures a more reliable ejection operation as described above.

In the above disc driving device 1, the first rotational arm 35 and the second rotational arm 36 are rotated in a position defined between the major surface of the top plate part 5a facing the and disc loading unit 23 and the major surface of the optical disc 2 introduced via the disc inserting/ejecting opening 19.

The result is that the effect of the clearance between the optical disc 2, introduced via the disc inserting/ejecting opening 19, and the base member 27, may be eliminated, thereby enabling the loading, centering and ejecting operations for the optical disc 2 to be carried out correctly in stability.

In particular, even in such a case where the small diameter disc 2B, out of the optical discs 2A, 2B of different outer diameters, is centered, and the base member 27 is uplifted to load the small diameter disc 2B on the turntable 23A, by way of chuck operations, it is possible to avoid the collision of the first rotational arm 35 and the second rotational arm 36 against the base member 27.

Consequently, the effect of the clearance between the optical disc 2, introduced via the disc inserting/ejecting opening 19, and the base member 27, which clearance tends to be narrower during the chuck operation, may be eliminated, to enable further reduction in size and weight of the device, as well as to enable coping with the optical discs 2A, 2B of different outer diameters.

In the above disc driving device 1, the first rotational arm 35 and the second rotational arm 36 are carried for sliding movement as the distal ends thereof are engaged in the guide groove 9 of the guide member 8 provided to the top plate part 5a. Hence, the first rotational arm 35 and the second rotational arm 36 may be rotated in stability between the major surface of the top plate part 5a facing the disc loading unit 23 and the major surface of the optical disc 2 inserted via disc inserting/ejecting opening 19.

Moreover, with the casing 3, the guide member 8, mounted to the front side of the top plate part 5a, operates as a reinforcement rib, as a result of which the top cover 5 may be improved in toughness. It is possible in this manner to prevent the vicinity of the disc inserting/ejecting opening 19 of the top cover 5 from being lowered in strength, as well as to improve operational reliability in mounting the optical disc 2 to the turntable 23a of the disc loading unit 23 by elevating the base member 27.

Thus, with the disc driving device 1, having a simplified structure, the optical discs 2A, 2B with different outer diameters may be coped with. It is unnecessary to use an adapter for using the small diameter disc 2B as the large diameter disc 2A, such that the operations of the device may be facilitated further. In addition, the operational reliability and low cost may be achieved simultaneously.

Moreover, with the present disc driving device 1, the number of the component parts may be reduced significantly to reduce the size and the weight of the device further, as compared to the conventional slot-in disc driving device 1 capable of coping with the optical discs 2A, 2B with different outer diameters. In particular, the disc driving device 1 is able to cope with the thickness on the order of 12.7 mm or 9.7 mm of the ultra-thin slot-in disc driving device loaded on the notebook personal computer 1000.

A specified structure for driving controlling the disc driving device 1 is now explained. In the following explanation, the parts or components equivalent to those of the disc driving device 1, described above, are depicted by the same reference numerals, and the corresponding description is omitted for simplicity. The parts or components different from those of the above-described disc driving device 1 or not explained in connection with the disc driving device 1 will be explained as necessary.

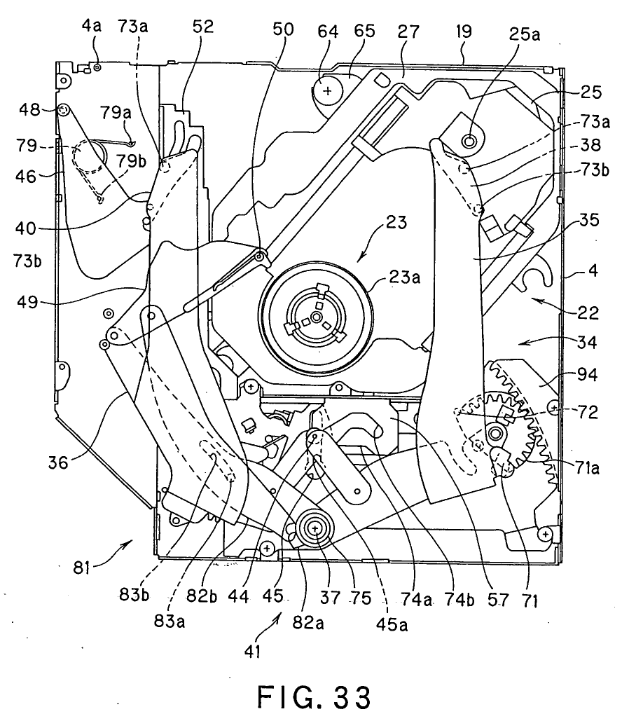

Out of the first to fourth rotational arms 35, 36, 46, 49, making up the disc transporting mechanism 34, the first rotational arm 35 and the second rotational arm 36, are mounted for rotation on the first forward surface side abutment member 38 and on the second forward surface side abutment member 40, via a forward pair and a rearward pair of rolls 73a, 73b, as shown in FIG. 33. Out of these paired rolls 73a, 73b, the forward side rolls 73a are abutted against the outer rim of the optical disc 2 during the loading and during the ejection, while the rearward side rolls 73b are abutted against the outer rim of the optical disc 2 during the centering described above. By allocating different functions to the paired rolls 73a, 73b, as described above, the loading, centering and the ejecting operations of the large diameter disc 2A and the small diameter disc 2B by the first rotational arm 35 and the second rotational arm 36 may be carried out reliably in stability.

With the above-described interlock mechanism 41, the first rotational arm 35 and the second rotational arm 36 need to be rotated in keeping with the large diameter disc 2A and the small diameter disc 2B of different outer diameters, as shown in FIGS. 33 to 35. Hence, the cam piece 57, bent from a mid part of the cam lever 56 towards above, is further bent horizontally substantially in the form of a letter U. This cam piece 57 has a horizontal surface section 57a formed with a first cam part 74a, associated with the large diameter disc 2A, and with a second cam part 74b, associated with the small diameter disc 2B, by cutting off the section on the forward side of the first cam part 74a in the form of a slit.

With the present interlock mechanism 41, the state of engagement of the second support shaft 44 with the first cam part 74a and the second cam part 74b is changed over depending on the difference in the opening degree of the first rotational arm 35 and the second rotational arm 36 when the large diameter disc 2A or the small diameter disc 2B is introduced via disc inserting/ejecting opening 19 of the optical disc 2.

Specifically, when the large diameter disc 2A is introduced, the second support shaft 44 is engaged with the first cam part 74a and is slid within the guide slit 45 in association operatively with the above-described sliding movement in the left-and-right direction of the cam lever 56. Hence, the first rotational arm 35 and the second rotational arm 36 may be rotated in a direction towards and away from each other in keeping with the outer diameter of the large diameter disc 2A.

When the small diameter disc 2B is introduced, the second support shaft 44 is engaged with the second cam part 74b and is slid within the guide slit 45 in association operatively with the above-described sliding movement in the left-and-right direction of the cam lever 56. Hence, the first rotational arm 35 and the second rotational arm 36 may be rotated in a direction towards and away from each other in keeping with the outer diameter of the small diameter disc 2B.

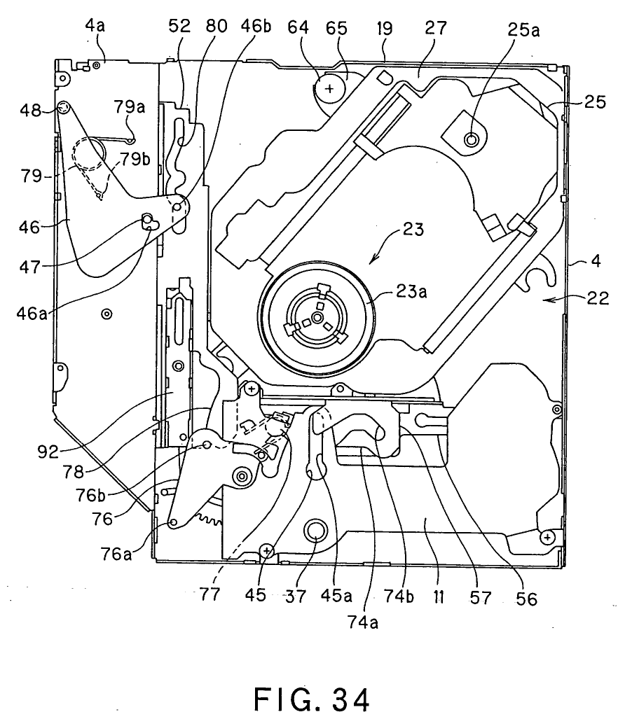

Referring to FIG. 34, the disc transporting mechanism 34 includes a first torsion coil spring 75 as biasing means for biasing the first rotational arm 35 and the second rotational arm 36 in a direction towards and away from each other. This first torsion coil spring 75 has a wound coil part engaged by the first support shaft 37 and, in this state, has its one end retained by the proximal end of the arm 35 and has its other end retained by the second rotational arm 36, for biasing the first rotational arm 35 and the second rotational arm 36 in a direction approaching to each other.

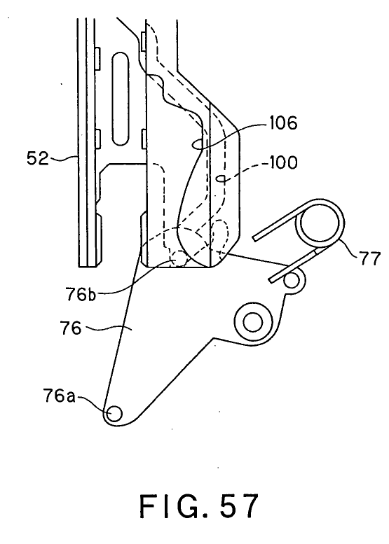

Referring to FIGS. 34 and 57, the disc transporting mechanism 34 includes, as biasing switching means for switching between the biasing state of biasing the first rotational arm 35 and the second rotational arm 36 in a direction approaching to each other, and a non-biasing state, a thrusting lever 76 for thrusting the second rotational arm 36, and a second torsion coil spring 77, as biasing means for biasing the thrusting lever 76 in a direction in which the first rotational arm 35 and the second rotational arm 36 are biased in a direction approaching to each other.

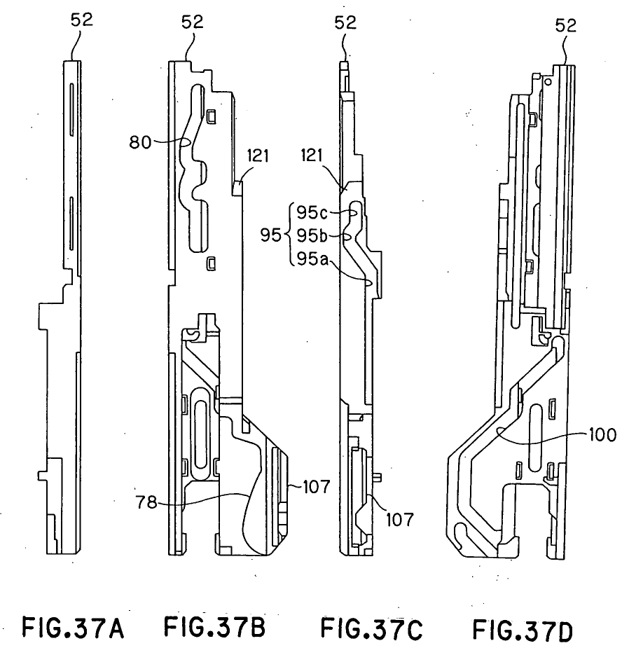

The thrusting lever 76 is an elongated sheet metal having an abutment pin 76a at one end for abutting against the second rotational arm 36, and a cam pin 76b at its other end for engaging in a cam groove 78 formed in the upper surface of the driving lever 52 shown in FIG. 37. The thrusting lever 76 is carried on the chassis 11 for rotation between an abutment position in which the abutment pin 76a is thrust against the second rotational arm 36 and a retreating position in which the cam pin 76b is spaced apart from the second rotational arm 36.

The second torsion coil spring 77 has its wound coil part engaged by the chassis 11 and, in this state, has its one end retained by the chassis 11 and its other end retained by the thrusting lever 76, so that the abutment pin 76a of the thrusting lever 76 abuts against the second rotational arm 36.

Thus, with the present disc transporting mechanism 34, it is possible, by the thrusting lever 76 thrusting the second rotational arm 36, to switch from a state in which the first rotational arm 35 and the second rotational arm 36 are biased in a direction approaching to each other, to a non-biased state, that is, a state in which the first rotational arm 35 and the second rotational arm 36 are not biased in this manner. In the non-biased state, when the driving lever 52 is slid up to the back surface side end, with the cam pin 76b of the thrusting lever 76 sliding in the cam groove 78 of the driving lever 52, in association operatively with the sliding of the driving lever 52 towards the back surface side, the thrusting lever 76 is rotated up to the retreated position, against the bias of the second torsion coil spring 77.

Referring to FIGS. 33 and 34, the third rotational arm 46 is biased by a torsion coil spring 79, arranged as a biasing means on the deck part 4a. This torsion coil spring 79 has its one end retained by a retention pin 79a of the deck part 4a, while having its other end retained by a retention pin 79b provided on the lower surface of the third rotational arm 46. The torsion coil spring 79 is able to switch the direction of the biasing force to the third rotational arm 46 between the direction of being thrust against the outer rim of the optical disc 2 and the direction of being separated from the outer rim of the optical disc 2.

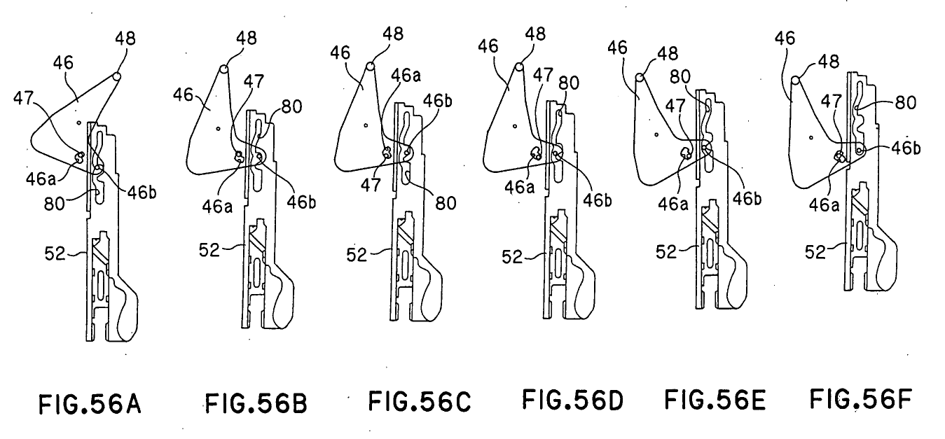

The third rotational arm 46 includes a substantially L-shaped shaft opening 46a, passed through by the support shaft 47, and a cam pin 76b, engaged in a cam groove 80 formed in the upper surface of the driving lever 52, shown in FIG. 37. This third rotational arm 46 is rotated by the cam pin 46b being slid in the cam groove 80, in association operatively with the sliding of the driving lever 52, as shown in FIG. 56. It is noted that the center of rotation of the third rotational arm 46 may be changed over depending on the position of the support shaft 47 in the shaft opening 46a.

The fourth rotational arm 49 is rotated, in association operatively with the sliding movement of the driving lever 52, via a link mechanism 81 shown in FIG. 33.

Specifically, this link mechanism 81 includes a crank arm 82a, rotatably carried via the first support shaft 37, and a connecting arm 82b interconnecting the crank arm 82a and the fourth rotational arm 49. The connecting arm 82b is formed with an elongated opening 83b passed through by a guide pin 83a provided on the second rotational arm 36. Thus, with the present crank mechanism, the crank arm 82a may be rotated in association cooperatively with the rotational movement of the fourth rotational arm 49.

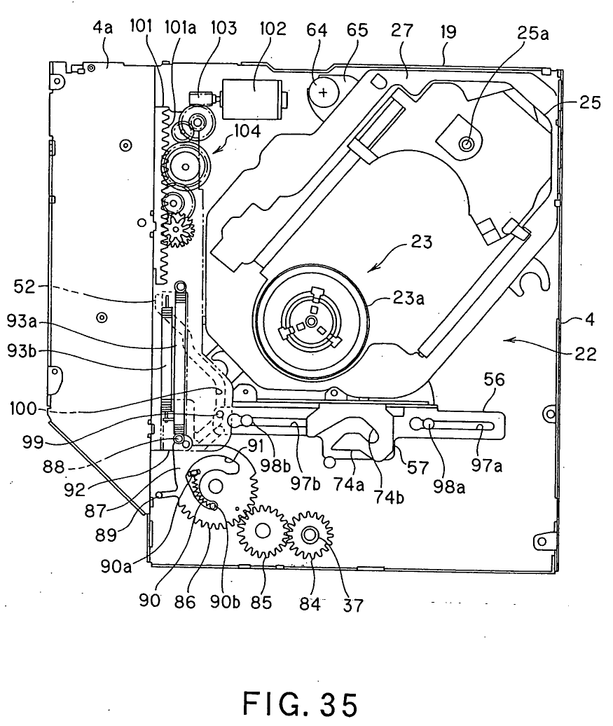

This link mechanism 81 includes, on the bottom surface of the bottom casing 4, a first gear 84, rotated via crank arm 82a, a second gear 85, meshing with the first gear 84, and a rotational member 87, formed with a third gear 86, meshing with the second gear 85, as shown in FIG. 35.

The rotational member 87 is used for rotating the fourth rotational arm 49 in association cooperatively with the sliding movement of the driving lever 52, and includes an engagement pin 88, engaged with the sliding member 92 of the driving lever 52 as later explained, and a positioning pin 89 abutted against the back side end of the driving lever 52 during recording and/or reproduction for positioning and securing the driving lever 52.

The rotational member 87 is biased by a tension coil spring 90, as a biasing means, in one rotating direction (counterclockwise direction in FIG. 35). This tension coil spring 90 has its one end retained by a retention pin 90a, provided on the bottom surface of the bottom casing 4, while having its other end retained by a retention pin 90b, provided to the rotational member 87, for biasing the rotational member 87 in one rotational direction. The rotational member 87 is formed with a substantially arcuate-shaped slit 91 for allowing the retention pin 90a to clear the rotational member 87.

On the back surface side of the driving lever 52 is mounted a slide member 92 capable of sliding in the fore-and-aft direction relative to the driving lever 52. This slide member 92 is biased towards the forward surface side by first and second tension coil springs 93a, 93b, and has its back surface end engaged by the engagement pin 88 of the rotational member 87, thereby rotating the rotational member 87 in association operatively with the slide movement of the driving lever 52.

Each of the first and second tension coil springs 93a, 93b has its forward side end retained by the driving lever 52, while having its back side end retained by the slide member 92, for biasing the slide member 92 towards the front side relative to the driving lever 52. Of these, the first coil spring 93a is used for actuating the usual driving lever 52 and the slide member 92 in unison, and has a spring force on the order of 200 to 300 gf. On the other hand, the second coil spring is used for protecting the mechanism in case the optical disc 2 cannot be ejected as normally, with the spring force being on the order of 400 to 600 gf.

Thus, with the present link mechanism 81, if the fourth rotational arm is rotated towards the back surface side during loading of the optical disc 2, the first gear 84 is rotated through the aforementioned crank mechanism 82. Then, by the meshing of the first gear 84, second gear 85 and the third gear 86, the rotational member 87 is rotated in the opposite rotational direction (herein the counterclockwise direction in FIG. 35) against the bias of the tension coil spring 90. This enables the driving lever 52 to be slid towards the back surface side in association operatively with rotation towards the back surface side of the fourth rotational arm.

In ejecting the optical disc 2, the driving lever 52 is slid towards the front surface side to cause rotation of the rotational member 87 in one rotational direction (herein counterclockwise in FIG. 35). Thus, by the meshing of the third gear 86, second gear 85 and the first gear 84, the fourth rotational arm may be rotated towards the front side via crank mechanism 82.

The fifth rotational member 71 includes a gear 71a, formed along a preset area of the outer rim part thereof, as shown in FIG. 33. This gear 71a meshes with an internal gear 94 arranged on the chassis 11 so as to be rotated in association operatively with the rotation of the first rotational arm 35.

For uplifting/lowering the base unit 22 by the base lift mechanism 55, the driving lever 52 includes a first cam slit 95, formed in the lateral surface thereof facing the base unit 22, as shown in FIG. 37c. This first cam slit 95 includes a first horizontal surface section 95a for setting the base unit 22 in the chuck releasing position, a top surface section 95b for setting the base unit 22 in the chuck releasing position, and a second horizontal surface section 95c for setting the base unit 22 in the intermediate position.

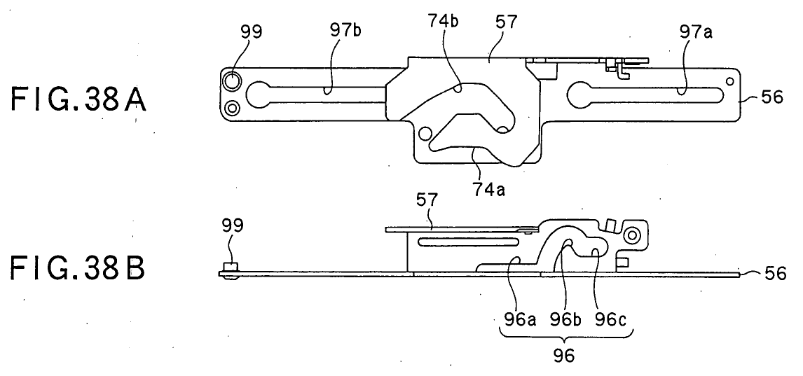

On the other hand, the cam piece 57 of the cam lever 56 is formed with a second cam slit 96, as shown in FIG. 38b. This second cam slit 96 includes a first horizontal surface section 96a for setting the base unit 22 in the chuck releasing position, a top surface section 96b for setting the base unit 22 in the chuck releasing position, and a second horizontal surface section 96c for setting the base unit 22 in the intermediate position.

The cam lever 56 includes paired forward and rear guide slits 97a, 97b, formed in its major surface. These guide slits 97a, 97b are engaged by paired headed guide pins 98a, 98b, protruded from the bottom surface section of the bottom casing 4, shown in FIG. 35, so that the cam lever is slid along the back side lateral surface of the base unit 22 in a direction substantially perpendicular to the slide direction of the driving lever 52, that is, in the left-and-right direction.

A guide pin 99 is formed at a point of intersection of the cam lever 56 with the driving lever 52 for protruding upwards. A guide slit 100, engaged by the guide pin 99, is formed in the bottom surface of the driving lever 52 shown in FIG. 37d. The cam lever 56 is slid in a direction perpendicular to the slide direction of the driving lever 52, by the guide pin 99 being slid within the guide slit 100 in association operatively with the sliding in the fore-and-aft direction of the driving lever 52, as shown in FIG. 35.

Referring to FIG. 5, the base member 27 includes a first support shaft 59, engaged in and carried by a first cam slit 95 of the driving lever 52. The first support shaft 59 is located towards the disc loading unit 23 on the lateral surface of the base member 27 facing the driving lever 52. The base member 27 also includes a second support shaft 60, engaged in and carried by a cam slit 96 of a cam piece 57 and in a vertically extending slit of the bent piece 58. The second support shaft 60 is located towards the disc loading unit 23 on the lateral surface of the base member 27 facing the driving lever 56. The base member 27 also includes a third support shaft 62 located on the front side of the base member opposite to the driving lever 52. The third support shaft is rotationally carried in a shaft opening 61 formed in the opposite lateral side of the bottom casing 4. The base member 27 also includes a fixed support 65 secured, such as by a set screw 64, to the bottom surface of the bottom casing 4 via an insulator 63, formed of a visco-elastic member e.g. of rubber. The fixed support 65 is located towards the front side of the base member opposite to the lateral side thereof facing the am lever 56.

Thus, in this base lift mechanism 55, the side towards the disc loading unit 23 of the base member 27 performs an up-and-down movement, relative to the front surface side, between the chuck position, chuck releasing position and the intermediate position, by the first support shaft 59 sliding in the first cam slit 95 of the driving lever 52, and by the second support shaft 60 sliding in the second cam slit 96 of the cam lever 56 and in the vertically extending slit in the bent piece 58, in association operatively with the sliding of the driving lever 52 and the cam lever 56.

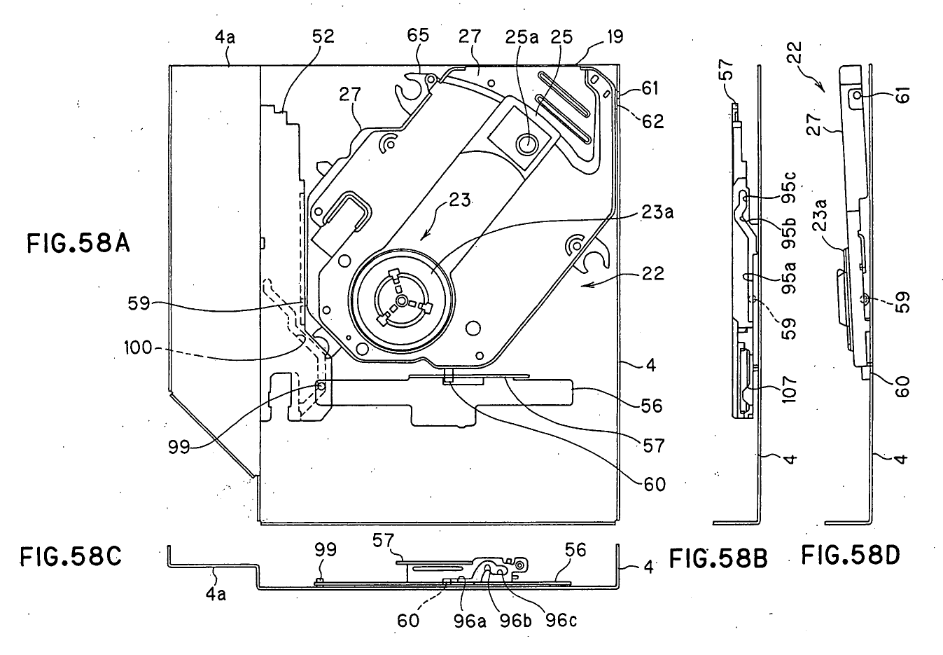

Specifically, in the chuck releasing position shown in FIG. 58, the first support shaft 59 is located on a first horizontal surface section 94a in the first cam slit 95, while the second support shaft 60 is positioned on a first horizontal surface section 96a in the second cam slit 96, by the cam lever 56 being slid eightwards in association operatively with the sliding of the driving lever 52 towards the forward surface side. This lowers the base unit 22 up to the chuck releasing position.

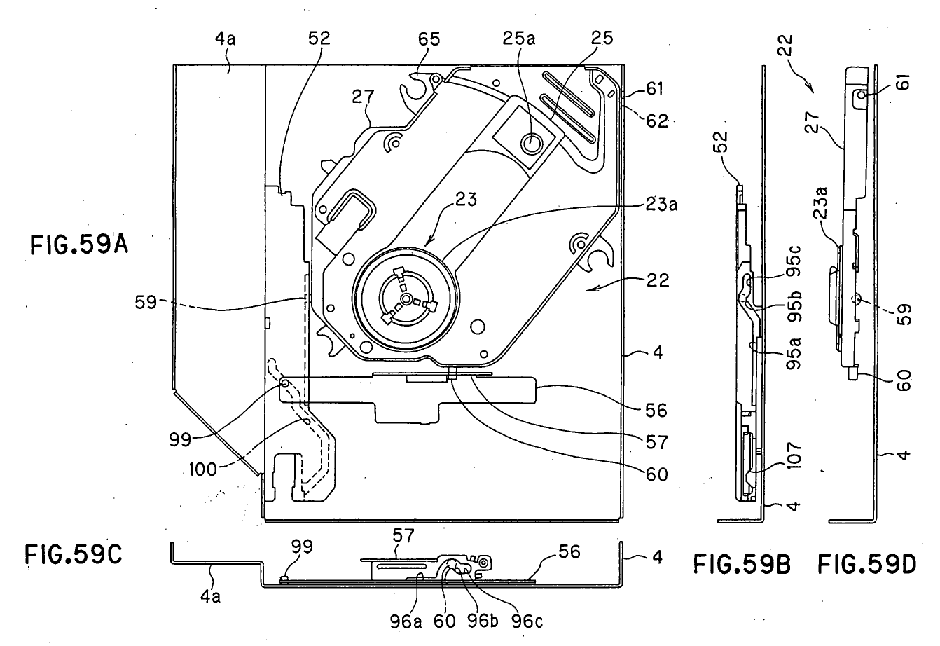

In the chuck position shown in FIG. 59, the first support shaft 59 is located on a top surface section 95b in the first cam slit 95, while the second support shaft 60 is positioned on a top surface section 96b in the second cam slit 96, by the cam lever 56 sliding leftwards in association operatively with the sliding towards the back surface side of the driving lever 52. This uplifts the base unit 22 up to the chuck position.

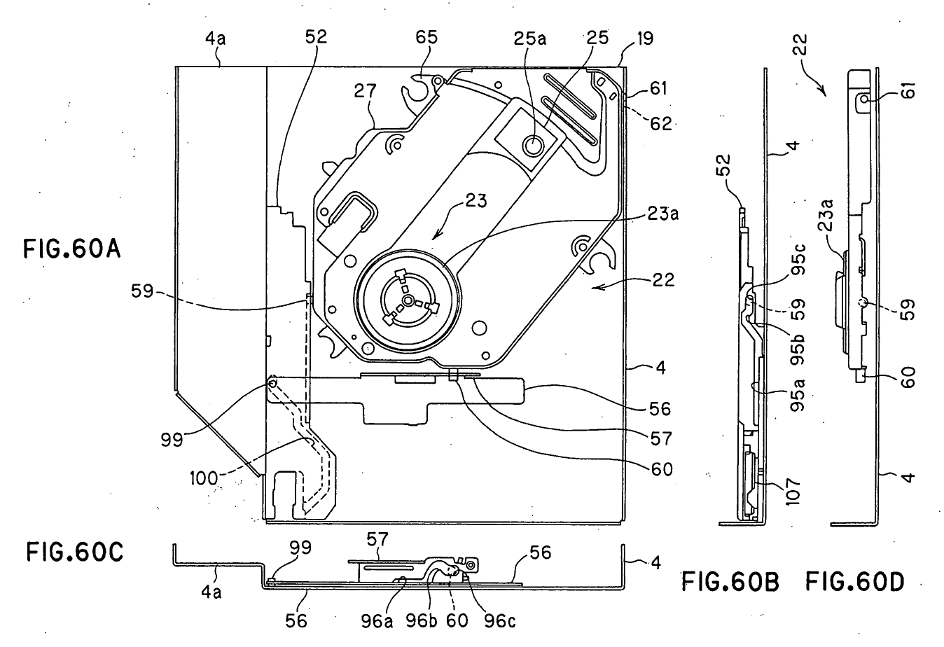

In the intermediate position shown in FIG. 60, the first support shaft 59 is located on a second horizontal surface section 95c in the first cam slit 95, while the second support shaft 60 is positioned on a second horizontal surface section 96c in the second cam slit 96, by the cam lever 56 sliding leftwards in association operatively with the sliding of the back surface side end of the driving lever 55. This lowers the base unit 22 up to an intermediate position between the chuck releasing position and the chuck position.

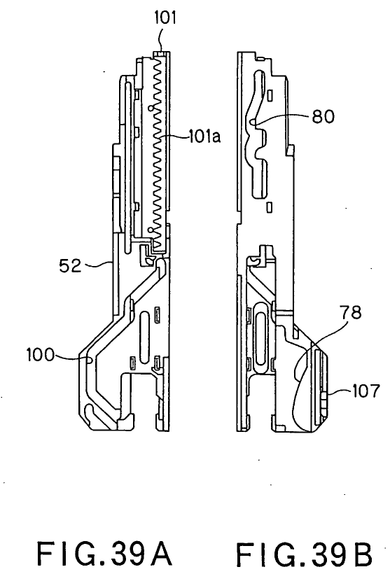

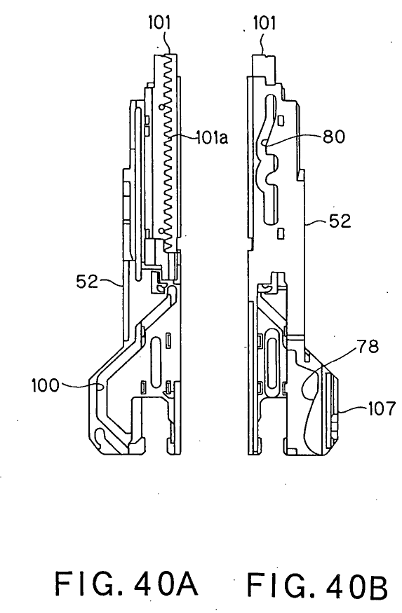

On the front surface side of the driving lever is mounted a rack member 101 that may be slid a preset stroke length in the fore-and-aft direction relative to the driving lever 52, as shown in FIGS. 39 and 40. A rack gear 101a is formed for extending in the fore-and-aft direction on the rack member 101. On the bottom surface section of the bottom casing 4, there are arranged a driving motor 102, forming a displacement driving mechanism, a worm gear 103 mounted to a rotational shaft of the driving motor 102, and a gear train 104 transmitting the motive power of the driving motor from the worm gear to the rack gear, as shown in FIG. 35.

Thus, with this displacement driving mechanism, the driving motor 102 is rotationally driven in one direction, for displacing and driving the driving lever 52 towards the back surface side of the driving lever 52, in unison with the rack member 101, as the rack member 101 is retracted towards the back surface side through the worm gear 103, gear train 104 and the rack gear 101a, as shown in FIG. 39. On the other hand, with the present displacement driving mechanism, the driving motor 102 is rotationally driven in the other direction, for displacing and driving the driving lever 52 towards the front surface side of the driving lever 52, in unison with the rack member 101, as the rack member 101 is retracted towards the front surface side through the worm gear 103, gear train 104 and the rack gear 101a, as shown in FIG. 40.

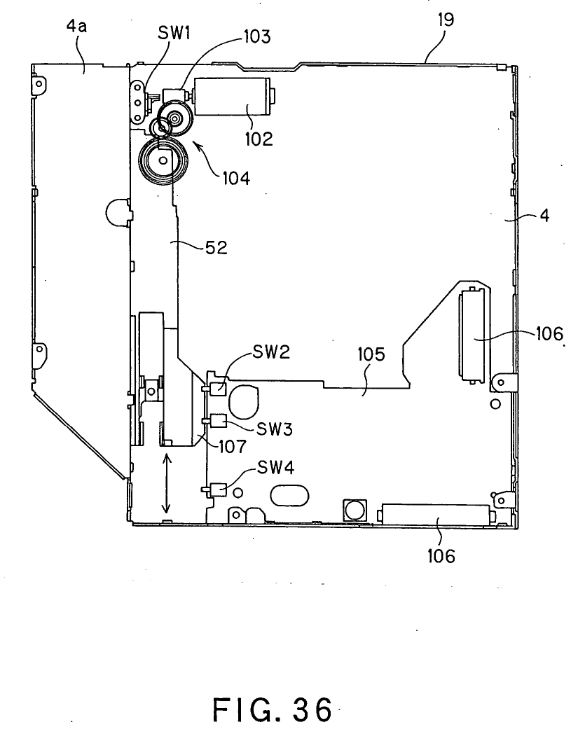

On the bottom surface section of the bottom casing 4 is mounted a circuit substrate 105, carrying thereon a driving control circuit responsible for driving and control of various components, as shown in FIG. 36. This circuit substrate 105 is mounted on the bottom surface section on the back surface side of the bottom casing 4 by set screws. On the bottom surface section of the bottom casing 4 and on the circuit substrate 105, there are arranged electronic components, not shown, such as IC chips, forming the driving control circuit, a connector 106 for electrical connection of various components, and detection switches SW1 to SW4 for detecting the operation of the various components.

Based on detection signals from these detection switches SW1 to SW4, the driving control circuit driving-controls the driving lever 52 by the displacement driving mechanism, as the driving control circuit detects the position of the driving lever 52 driven by the aforementioned displacement driving mechanism.

Of these switches, the first detection switch SW1 is arranged in the forward surface side end of the bottom casing 4. This first detection switch SW1 has its on/off state switched by the forward side end of the driving lever 52. On the other hand, the second to fourth detection switches SW2 to SW4 are arrayed side-by-side, at a preset interval from one another, at an end edge facing the driving lever 52 of the circuit substrate 9. The on/off state of these second to fourth detection switches SW2 to SW4 is switched by a cam section 107 provided to the lateral surface of the driving lever 52 shown in FIGS. 37b and 37c.

The specified driving control of the disc driving device 1, constructed as described above, is hereinafter explained.

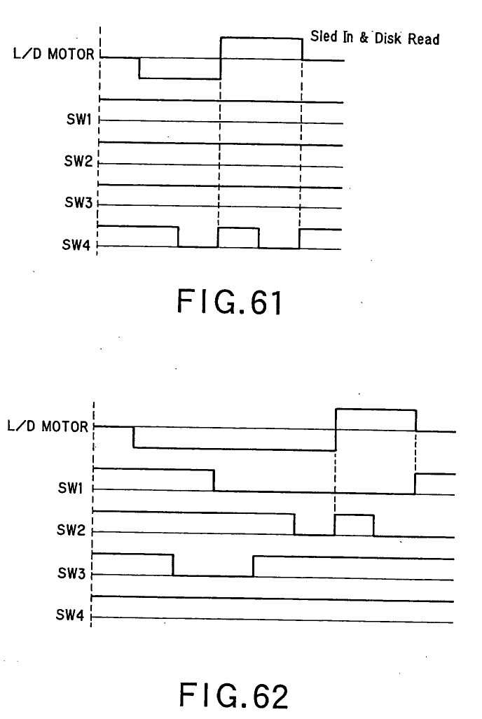

If, with the present disc driving device 1, the optical disc 2 has been inserted in position, the default operations prior to the insertion of the optical disc 2 are carried out, as driving control of the driving lever 55 is carried out in accordance with the timing chart shown in FIG. 61. If otherwise, the default operations prior to the insertion of the optical disc 2 are carried out, as driving control of the driving lever 55 is carried out in accordance with the timing chart shown in FIG. 62.

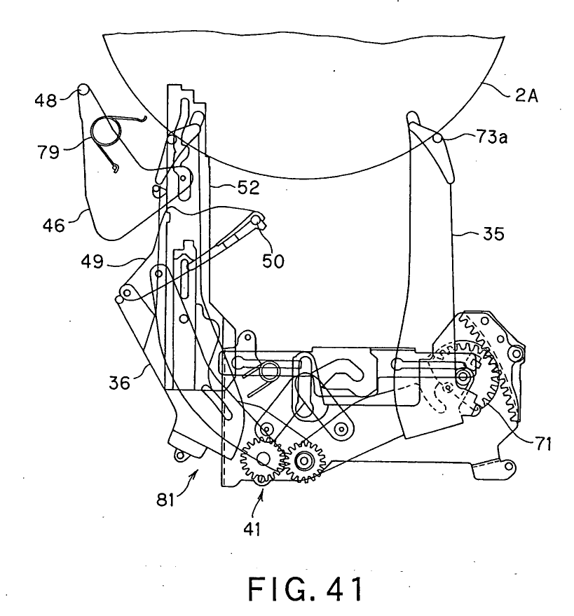

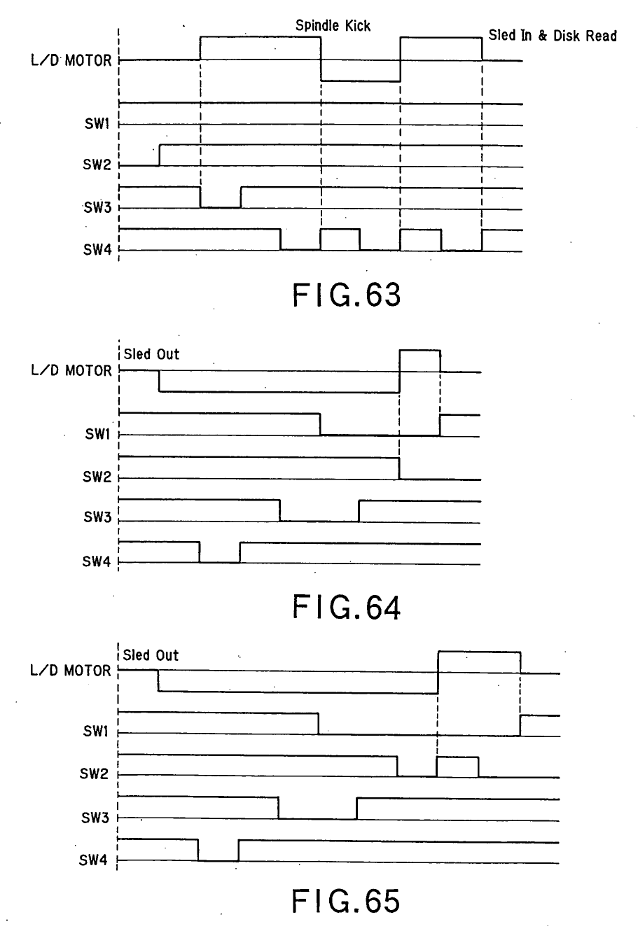

When next the large diameter disc 2A is inserted through the disc inserting/ejecting opening 19 of the casing 3, the large diameter disc 2A, shown in FIGS. 41 to 44, is loaded, as driving control of the driving lever 55 is carried out in accordance with the timing chart shown in FIG. 63.

Specifically, in the state of insertion start of the large diameter disc 2A, shown in FIG. 41, the driving lever 52 is biased towards the front surface side, by the abutment pin 76a of the thrusting lever 76 being thrust against the driving lever 52, for biasing the driving lever 52 towards the front surface side. Additionally, the driving lever 52 is subjected to a force of thrust towards the front surface side, by the cam pin 76b of the thrusting lever 76 thrusting the cam groove 78 of the driving lever 52.

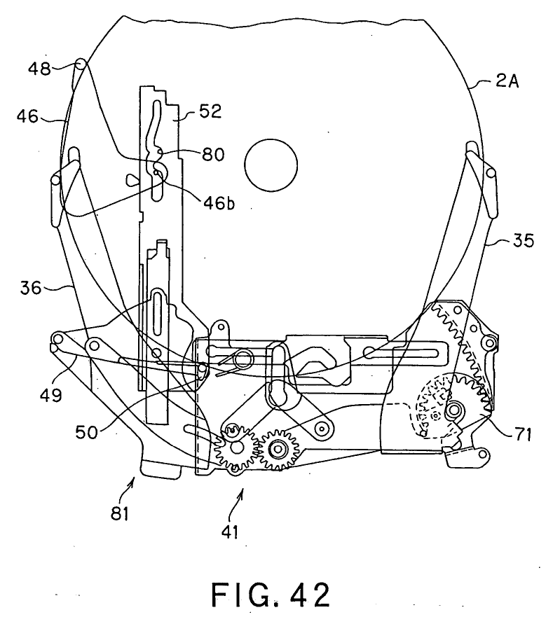

In the loading start state of the large diameter disc 2A, shown in FIG. 42, when the fourth rotational arm 49, thrust by the large diameter disc 2A, is rotated towards the back surface side, the driving lever 55 is slid towards the back surface side via link mechanism 51. At this time, the movement of the cam pin 46b of the third rotational arm 46 in the cam groove 80 of the driving lever 52 is inhibited. Consequently, the slide member 92 is moved towards the back surface side, against the bias of the first tension coil spring 93a. When the third rotational arm 46 has been rotated to a preset angular position, that is, when it has become possible to pull the large diameter disc 2A inwards, the driving control circuit detects that the driving lever 52 has been moved a preset stroke towards the back surface side to start rotational driving of the driving motor 102 in one direction.

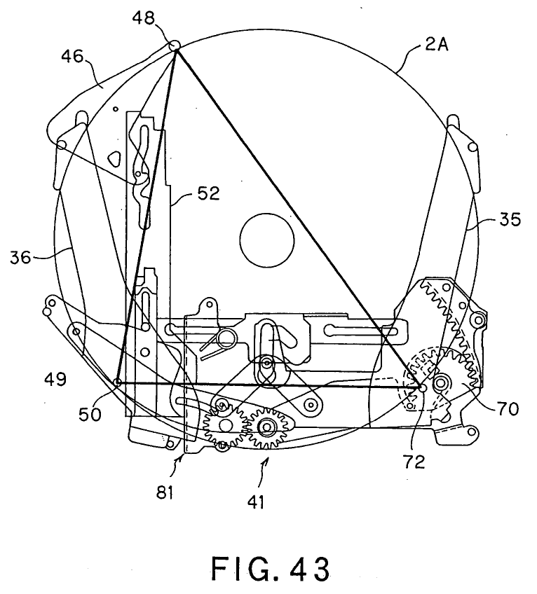

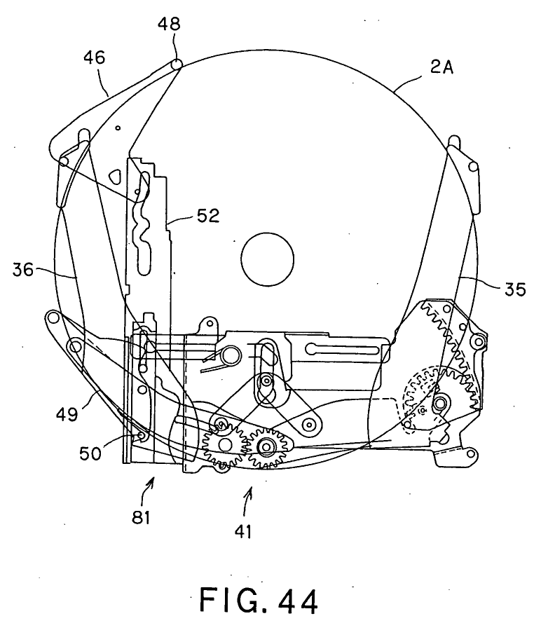

In the centering state of the large diameter disc 2A, shown in FIG. 43, the centering of the large diameter disc 2A is carried out between the third abutment member 48 of the third rotational arm 46, the fourth abutment member 50 of the fourth rotational arm 49 and the fifth abutment member 72 of the fifth rotational member 71. The chuck operation for the large diameter disc 2A is then completed, as shown in FIG. 44.

In this disc drive device 1, the base unit 22 is uplifted to the chuck position to load the large diameter disc 2A on the turntable 23a, by way of a first chuck operation. The base unit 22 is lowered to an intermediate position, the spindle motor 24a rotationally drives the large diameter disc 2A, the disc is phase-offset, the base unit 22 is again uplifted to the chuck position and the large diameter disc 2A is loaded on the turntable 23a, by way of a second chuck operation.

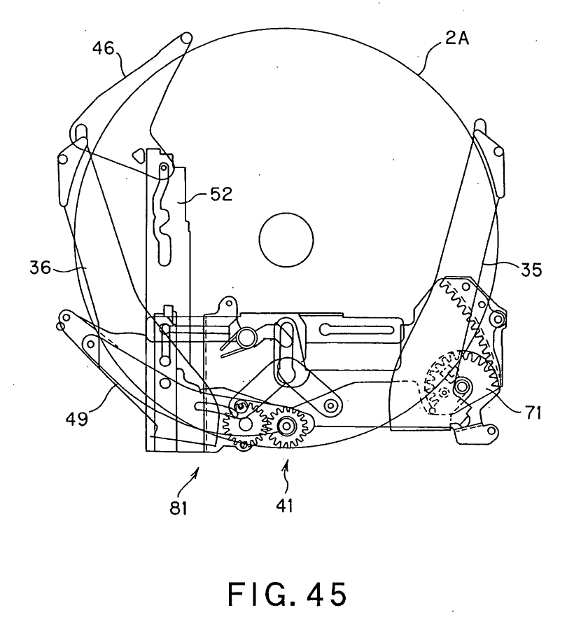

Next, in the recording and/or reproducing state of the large diameter disc 2A, shown in FIG. 45, the third abutment member 48 of the third rotational arm 46, the fourth abutment member 50 of the fourth rotational arm 49 and the fifth abutment member 72 of the fifth rotational member 71 are spaced apart from the outer rim of the large diameter disc 2A.

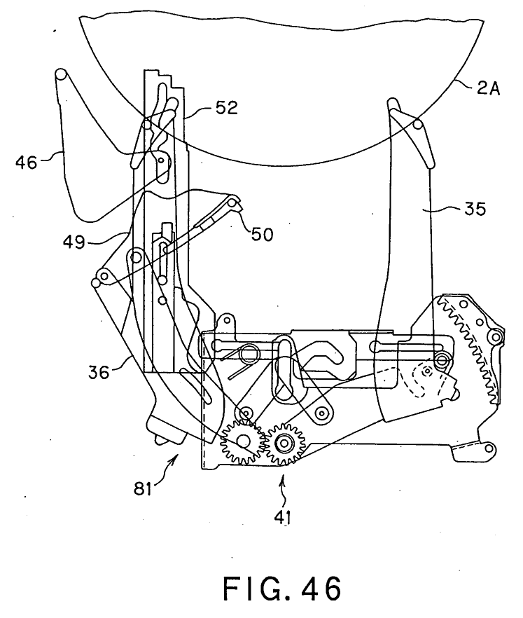

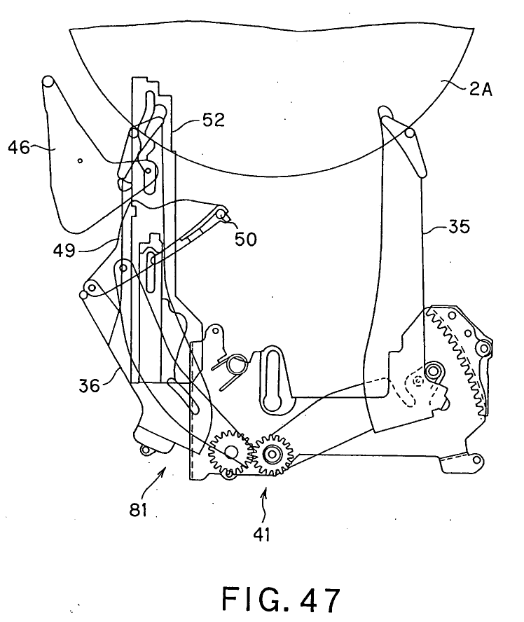

On the other hand, in the present disc drive device 1, the large diameter disc 2A, shown in FIGS. 46 and 47, is ejected, as driving control is carried out in accordance with the timing chart shown in FIG. 64.

It is noted that, in ejecting the large diameter disc 2A, shown in FIG. 46, the third rotational arm 46 is rotated in a direction away from the outer rim of the large diameter disc 2A, at a timing faster than in loading, by switching of the position of the support shaft 47 in the shaft opening 46a of the third rotational arm 46.

In more detail, this third rotational arm 46 shifts to a state shown in FIG. 56b, from a state shown in FIG. 56a, in association operatively with the slide movement of the driving lever 52 towards the front surface side. At this time, the third rotational arm 46 is rotated counterclockwise, by the cam pin 46b sliding in a rightwardly bent part in the cam groove 80.

When the third rotational arm assumes the state shown in FIG. 56c, the third rotational arm 46 is thrust towards left by the cam pin 44b abutting against an inclined surface in the cam groove 80. At this time, the support shaft 47 traverses the linear part corresponding to the lower arm of the upper case letter L of the shaft opening 46a. At this time point, ejection of the large diameter disc 2A becomes possible.

When the third rotational arm assumes the state shown in FIG. 56d, the third rotational arm 46 is fully opened, by the position of the support shaft 47 in the shaft opening 46a being switched to the right side end of the upper case letter L, with this position as the center of rotation.

When the third rotational arm assumes the state shown in FIG. 56e, the third rotational arm 46 is switched to the left side end of the upper case letter L, under the bias of the torsion coil spring 79, so that reversion is made to the state prior to loading.

Thus, with the present disc drive device 1, it is possible to prevent the third rotational arm 46 from being suddenly opened from the state the second tension coil spring 93b has been extended at the time of ejection, by changing over the center of rotation of the third rotational arm 46, so that it is possible to perform the ejecting operation of the large diameter disc 2A in stability.

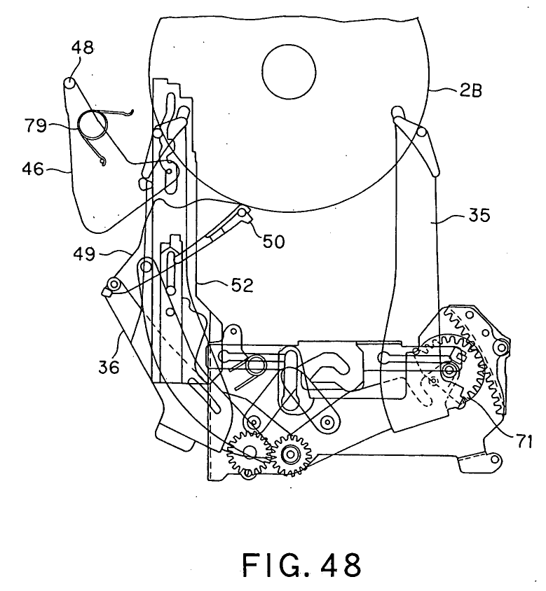

On the other hand, if the small diameter disc 2B is inserted via the disc inserting/ejecting opening 19 of the casing 3, the operation of loading the small diameter disc 2B, shown in FIGS. 48 to 52, is carried out, under driving control of the driving lever 52 in accordance the timing chart shown in FIG. 63, as in the case of the large diameter disc 2A.

Specifically, in the insertion start state of the small diameter disc 2B, shown in FIG. 48, the driving lever 52 is biased towards the front surface side of the driving lever 52, by the abutment pin 76a of the thrusting lever 76 thrust against the driving lever 52. On the other hand, the driving lever 52 is subjected to a force of thrust acting towards the front side of the driving lever 52, by the cam pin 76b of the thrusting lever 76 thrusting the cam groove 78 of the driving lever 52.

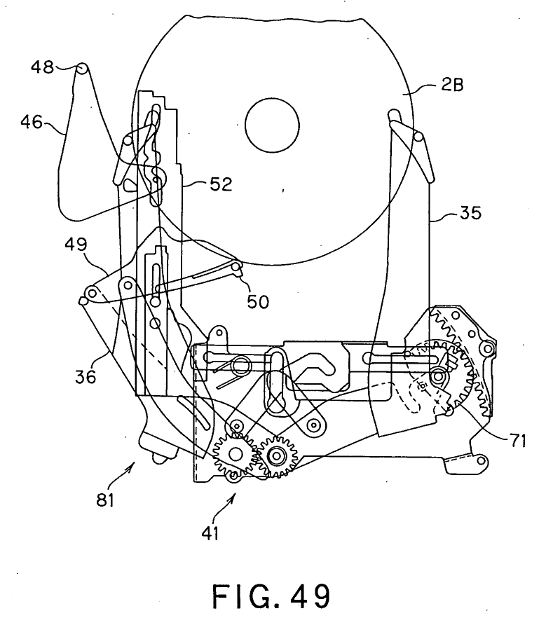

If, in the loading start state of the small diameter disc 2B, shown in FIG. 49, the fourth rotational arm 49, thrust by the small diameter disc 2B, is rotated towards the back surface side, the driving lever 52 is slid towards the back surface side, by the link mechanism 81. The driving control circuit detects that the driving lever 52 has been moved a preset stroke towards the back surface side, and the rotational driving in one direction of the driving motor 102 commences. With the third abutment member 48 being thrust against the outer rim of the small diameter disc 2B, the third rotational arm 46 is rotated in a direction of retracting the small diameter disc 2B inwards.

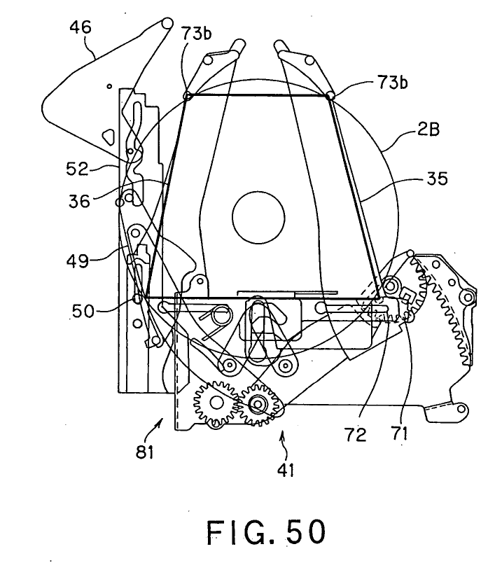

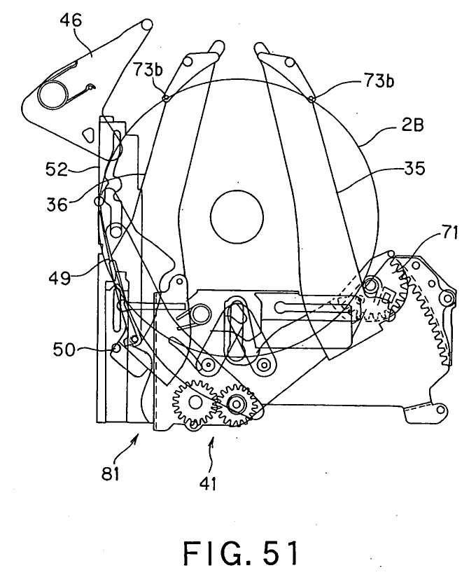

Then, in the centering state of the small diameter disc 2B, shown in FIG. 50, the centering operation of the large diameter disc 2A is carried out between the back surface side roll 73b provided to the first forward surface side abutment member 38 of the first rotational arm 35, back surface side roll 73b provided to the second forward surface side abutment member 40 of the second rotational arm 36, fourth abutment member 50 of the fourth rotational arm 49 and the fifth abutment member 72 of the fifth rotational arm 71. This completes the chucking of the large diameter disc 2A, as shown in FIG. 51.

In this disc drive device 1, the base unit 22 is uplifted to the chuck position to load the small diameter disc 2B on the turntable 23a, by way of a first chuck operation. The base unit 22 is lowered to an intermediate position, the spindle motor 24a rotationally drives the small diameter disc 2B, the disc is phase-offset, the base unit 22 is again uplifted to the chuck position and the small diameter disc 2B is loaded on the turntable 23a, by way of a second chuck operation.

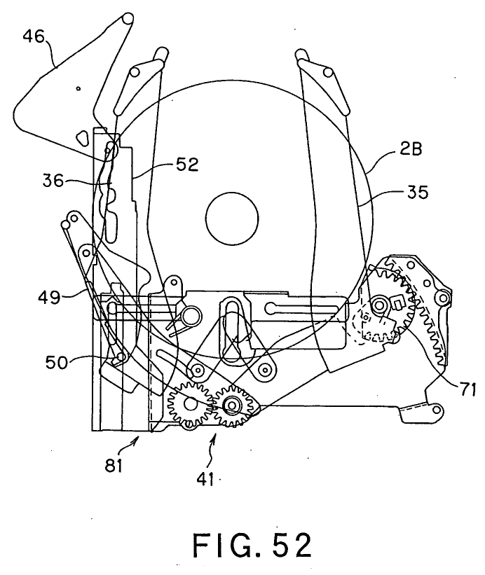

Next, in the recording and/or reproducing state of the small diameter disc 2B, shown in FIG. 52, the back surface side roll 73b provided to the first forward surface side abutment member 38 of the first rotational arm 35, back surface side roll 73b provided to the second forward surface side abutment member 40 of the second rotational arm 36, fourth abutment member 50 of the fourth rotational arm 49 and the fifth abutment member 72 of the fifth rotational arm 71 are spaced apart from the outer rim of the small diameter disc 2B.

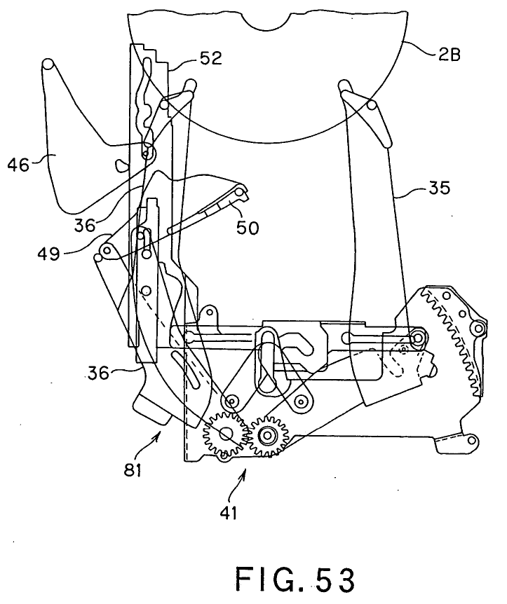

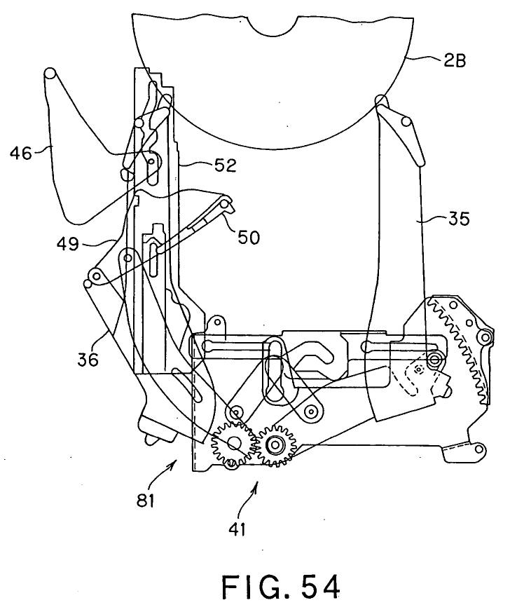

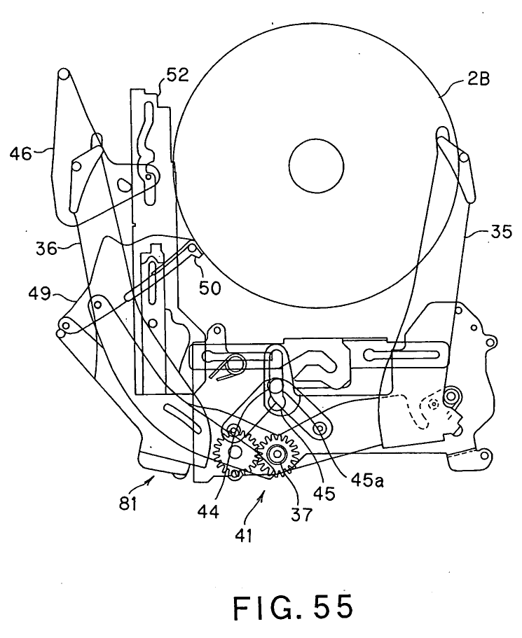

On the other hand, in the present disc drive device 1, the small diameter disc 2B, shown in FIGS. 53 and 54, is ejected, as driving control is carried out in accordance with the timing chart shown in FIG. 65.

Specifically, in the state of ejection of the small diameter disc 2B, shown in FIG. 53, the fourth rotational arm 49 is rotated towards the front side via the link mechanism 81, as the driving lever 52 is slid towards the forward side. The abutment pin 76a of the thrusting lever 76 is thrust against the driving lever 52 to bias the first rotational arm 35 and the second rotational arm 36 in a direction approaching to each other. This enables the small diameter disc 2B to be ejected vigorously, as shown in FIG. 54.

Meanwhile, if, in the present disc drive device 1, the small diameter disc 2B is inserted from a position offset towards the first rotational arm 35 of the disc inserting/ejecting opening, the first rotational arm 35 and the second rotational arm 36 are rotated in a direction away from each other through the link mechanism. However, the second support shaft, slid within the guide slit 45, is caught by a curved section 45a, curved leftwards, such that rotation of the first rotational arm 35 and the second rotational arm 36 in a direction away from each other is restrained to inhibit further insertion of the small diameter disc 2B.

Thus, with the disc drive device, it is possible to prevent the loading of the small diameter disc 2B from not being carried out properly.

Meanwhile, in case the small diameter disc 2B is inserted from a location offset towards the second rotational arm 36 of the disc inserting/ejecting opening, rotational driving in one direction of the driving motor 102 commences at an early timing. Hence, there is no problem raised which is pertinent to the offsetting of the small diameter disc 2B towards the first rotational arm 35.

Meanwhile, with the present disc drive device 1, the driving of the driving lever towards the back side may be started at a time point when the driving lever 52 is slid by the same stroke distance towards the back surface side, no matter whether the disc inserted is the large diameter disc 2A or the small diameter disc 2B. Hence, it is possible to drive the driving lever 52 subsequently by the same sequence control, so that the structure may be simplified without the necessity of providing separate detection switches for the large diameter disc 2A and the small diameter disc 2B with different outer diameters.

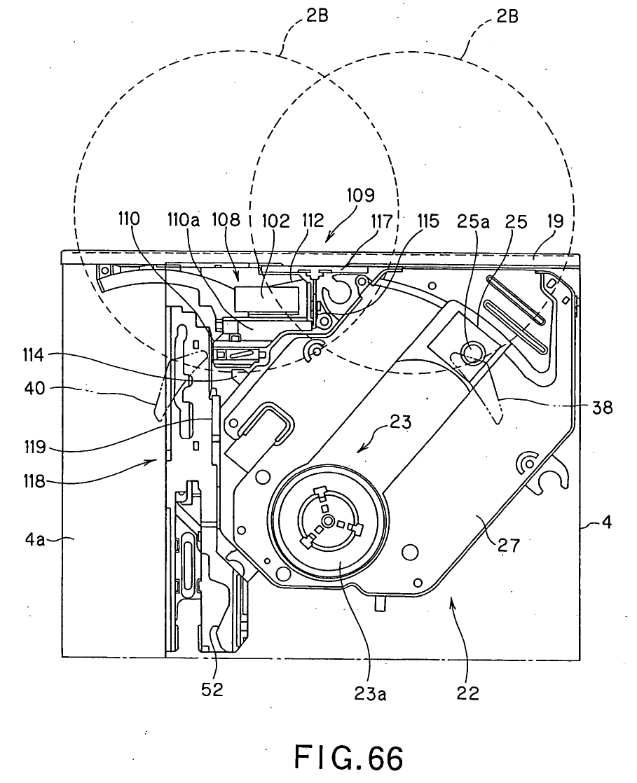

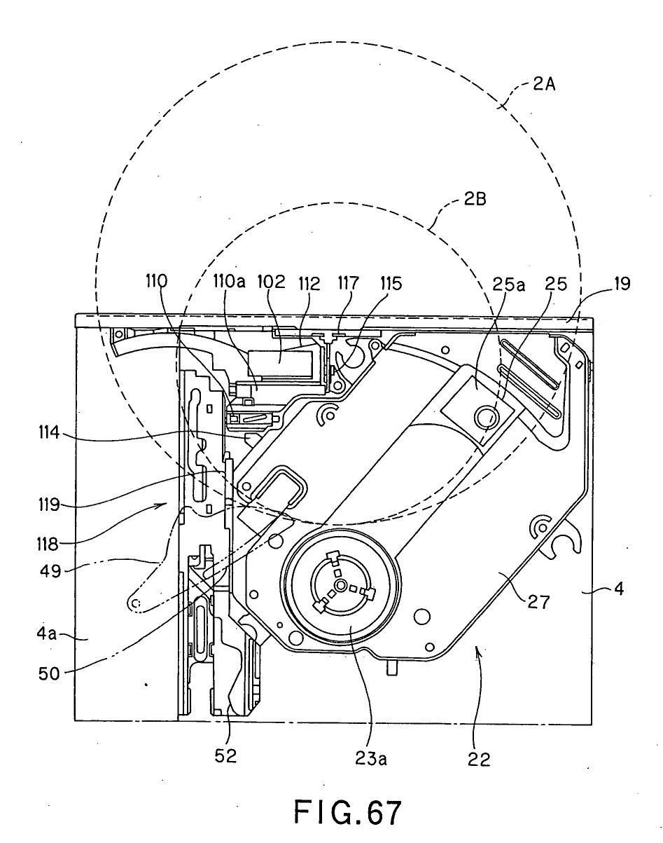

Referring to FIGS. 66 and 67, the disc drive device 1 includes, on the front side of the bottom casing 4, a first disc guide mechanism 108 for guiding the optical disc 2 inserted via the disc inserting/ejecting opening 19, under regulation of the angle of insertion of the optical disc 2, and a shutter opening/closing mechanism 109 for preventing the new optical disc 2 from being inserted via the disc inserting/ejecting opening 19 into the inside of the casing 3.

Referring to FIGS. 66 to 68, the first disc guide mechanism 108 includes an insertion guide lever 110 uplifted and lowered in synchronism with the vertical movement of the base unit 22 by the base lift mechanism 55. This insertion guide lever 110, formed by a resin member subjected to friction with the optical disc 2 only to a lesser extent, is arranged along the direction of insertion of the optical disc 2, and is carried for rotation by having a support shaft 111 at the proximal end thereof engaged in a bearing 113 provided to the back side of a motor casing 112. On the upper surface section of the insertion guide lever 110, a horizontal guide piece 110a, formed for extending along the disc inserting/ejecting opening 19, is protuberantly formed towards the front surface side, in order to cope with the large diameter disc 2A and the small diameter disc 2B. A thrust piece 10b, thrust by a thrusting piece 114, provided to the base member 27, is protuberantly formed on the back surface of the insertion guide lever 110.

The lower surface of guide piece 110a of the insertion guide lever 110 is engaged by an end of a torsion bar 115 carried by the back surface of the motor casing 112. This torsion bar 115, introduced through a torsion coil spring 116, mounted to the motor casing 112, has its one end and its other end turned upwards and downwards, respectively, under the force of bias of the torsion coil spring 116.

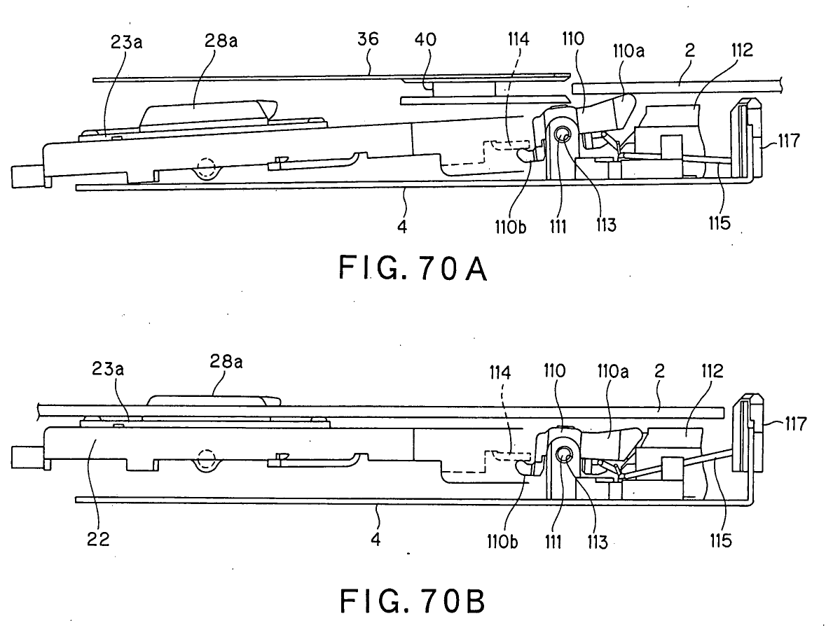

With the present first disc guide mechanism 108, the guide piece 110a of the insertion guide lever 110 can be uplifted to a position of regulating the angle of insertion of the optical disc 2, introduced via the disc inserting/ejecting opening 19 by thrusting the thrust piece 110b of the insertion guide lever 110 downwards by the thrusting piece 114 of the base member 27 when the base member 27 is in the chuck releasing position, as shown in FIG. 70a. Conversely, when the base member 27 is in the intermediate position, the guide piece 110a of the insertion guide lever 110 can be lowered to a position spaced apart from the signal recording surface of the optical disc 2, loaded on the turntable 23a, by releasing the pressure of the thrusting piece 114 of the base member 27 against the thrust piece 110b of the insertion guide lever 110, as shown in FIG. 70b.

Thus, with the present disc drive device, in which the second disc guide mechanism 108 uplifts and lowers the insertion guide lever 110, in association operatively with the uplifting/lowering movement of the base member 27 by the base lift mechanism 55, it is possible to prevent the signal recording surface of the disc 2 from being contacted with and thereby damaged, by the guide piece 110A of the insertion guide lever 110 regulating the angle of insertion of the optical disc 2 (the large diameter disc 2A or the small diameter disc 2B differing in outer diameter) via disc inserting/ejecting opening 19. In particular, the guide piece 110a of the insertion guide lever 110 has a transversely elongated shape along the disc inserting/ejecting opening 19 and hence is able to cope not only with the large diameter disc 2A but also with the small diameter disc 2B lesser in outer diameter than the large diameter disc 2A.

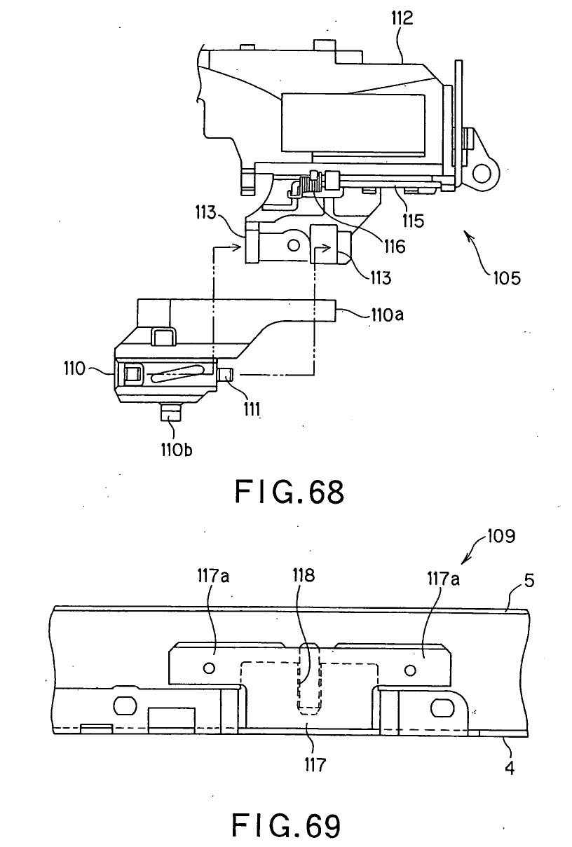

Referring to FIGS. 66, 67 and 69, the shutter opening/closing mechanism 109 includes a shutter member 117 uplifted/lowered in synchronism with the uplifting/lowering movement of the insertion guide lever 110 by the first disc guide mechanism 108. This shutter member 117 is a substantially flat-plate shaped and is carried for sliding in the up-and-down direction by having its back surface engaged in a vertical slit 118 formed in the front surface of the bottom casing 4. The lateral surfaces of the shutter member 117 are provided with paired shutter pieces 117a, extended along the disc inserting/ejecting opening 19, for coping with the large diameter disc 2A and the small diameter disc 2B. The shutter member 117 has its back surface carried by the opposite end of the torsion bar 115. This holds the shutter member 117 downwards.

The shutter member 117 may be uplifted/lowered between the closed position of closing the path of the optical disc 2 inserted through the disc inserting/ejecting opening 19 and the opened position of opening the path of the optical disc 2 inserted through the disc inserting/ejecting opening 19, in timed relation to the uplifting/lowering movement of the insertion guide lever 110 by the first disc guide mechanism 108.

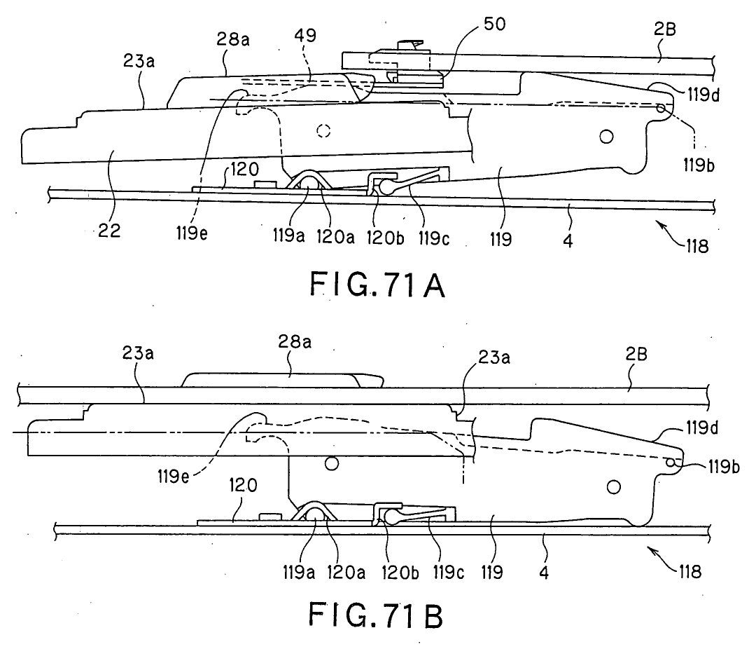

Specifically, with the present shutter opening/closing mechanism 109, the shutter member 117 may be lowered to the open position of opening the path of the optical disc 2, introduced via the disc inserting/ejecting opening 19, when the base member 27 is in the chuck releasing position, as shown in FIG. 71a. On the other hand, if, with the present shutter opening/closing mechanism 109, the base member 27 is in the intermediate position, and the insertion guide lever 110 is uplifted, the torsion bar 115, carried by the motor casing 112, is rotated about its axis to uplift the shutter member 117, as shown in FIG. 71b. This enables the shutter member 117 to be uplifted to a closure position of closing the path of the optical disc 2, introduced via the disc inserting/ejecting opening 19.

Thus, with the present disc drive device, it is possible to prevent the new large diameter disc 2A or the new small diameter disc 2B from being introduced via the disc inserting/ejecting opening 19 into the inside of the casing 3 in a state in which an optical disc 2 has already been loaded on the turntable 23a. In particular, the paired shutter pieces 117a of the shutter member 117 include wing shaped portions, extended along the disc inserting/ejecting opening 19, it is possible to prevent the small diameter disc 2B from being introduced via the gap defined between the shutter member 117 and the disc inserting/ejecting opening 19.

Referring to FIGS. 66, 67 and 71, the disc drive device 1 includes a second disc guide mechanism 118 for guiding the small diameter disc 2B, inserted via the disc inserting/ejecting opening, into the inside of the casing 3, under controlling the height of the small diameter disc 2B to a height that may be abutted against the fourth abutment member 50 of the fourth rotational arm 49.

This second disc guide mechanism 118 includes, in the vicinity of the distal end of the fourth rotational arm 49, a guide lever 119 that may be uplifted/lowered in synchronism with the uplifting/lowering movement of the base unit 22 by the base lift mechanism 55. This guide lever 119 is formed of a resin member having less friction with the optical disc 2 and is arranged for extending along the direction of insertion of the small diameter disc 2B. In addition, the guide lever is rotationally carried by the support shaft 119a, provided to the distal end, engaging with a bearing part 120a of the bearing member 120 provided to the bottom surface section of the bottom casing 4.

On the distal end of the guide lever 119, there is formed as guide pin 119b for protruding towards the driving lever 52. On the other hand, the driving lever 52 is provided with a cam 121, adapted to have a sliding contact with the guide pin 119b, as shown in FIGS. 39b and 39c. On the proximal side of the guide lever 113, there is formed an elastic piece 119c for extending from the front side towards the back side. The distal end of the elastic piece 119c is retained by a retention part 120b of the bearing member 120. Hence, the distal end of the guide lever 119 is biased downwards under the force of elasticity of the elastic piece 119c.

On the upper surface of the front surface side of the guide lever 119, there is formed a disc guide part 119d for guiding the small diameter disc 2B, inserted via the disc inserting/ejecting opening 19, onto the fourth abutment member 50 of the fourth rotational arm 49. On an upper surface section of the back surface side of the guide lever 119 is formed an arm guide unit 119e for guiding the fourth rotational arm 49 from the back surface side towards the front surface side, under regulating the fourth rotational arm 49 in its height-wise direction, in ejecting the small diameter disc 2B via the disc inserting/ejecting opening 19 to outside the casing 3. This enables avoiding the collision of the fourth rotational arm 49 of the fourth abutment member 50 against the engagement projection 28a of the turntable 23a in case the fourth rotational arm 49 is rotated from the back surface side towards the front surface side.

When the driving lever 52 is slid in the fore-and-aft direction, the guide pin 119b is slid on the upper surface of the cam 121 whereby the guide lever 119 may be uplifted or lowered between the guide position of regulating the small diameter disc 2B, inserted via the disc inserting/ejecting opening 19, in the height-wise direction, and a retracted position of being retracted from the lower surface of the small diameter disc 2B loaded on the turntable 23a.

Thus, with the present disc drive device, the second guide lever, located in the vicinity of the distal end of the fourth rotational arm 49, is able to guide the small diameter disc 2B, inserted via the disc inserting/ejecting opening 19, into the inside of the casing 3, when the small diameter disc 2B is inserted via the disc inserting/ejecting opening 19, as the second guide lever regulates the small diameter disc 2B to a height that can be abutted against the fourth abutment member 50 of the fourth rotational arm 49, thereby enabling subsequent proper and reliable loading of the small diameter disc 2B.

It is noted that the insertion guide lever 110 is located in the vicinity of the distal end of the second rotational arm 36 and has the function similar to that of the guide lever 119, that is, the function of guiding the optical disc 2, inserted via the disc inserting/ejecting opening 19, into the inside of the casing 3, under regulating the height of the optical disc 2, to such a height that may be abutted against the fourth abutment member 50 of the fourth rotational arm 49.

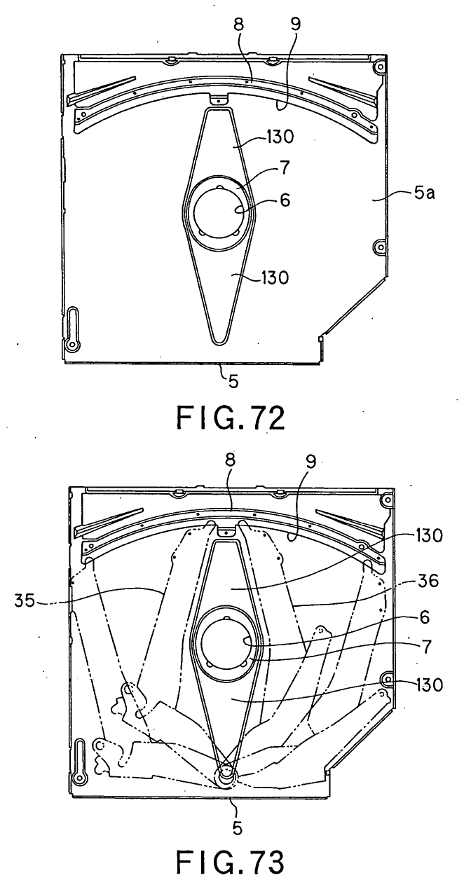

The above disc drive device 1 may be provided with a reinforcement bead 130 for increasing the toughness of the top plate part 5a of the top cover 5, as shown in FIG. 72. This bead 130 is a portion of the major surface of the top plate part 5a facing the disc loading unit 23 and which is slightly protruded towards the inner side of the casing 3, with the opposite side being concave, as shown in FIG. 73. The bead 130 is provided in an area of the major surface of the top plate part excluding the range of movement of the first rotational arm 35 and the second rotational arm 36, specifically, in an area of the major surface of the top plate part facing the disc loading unit 23 between the first rotational arm 35 and the second rotational arm 36.

With the present disc drive device 1, the first rotational arm 35 and the second rotational arm 36 are rotated in an area between the major surface of the top plate part 5a facing the disc loading unit 23 and the major surface of the optical disc 2 inserted via the disc inserting/ejecting opening 19. Thus, with the present disc drive device 1, the reinforcement bead 130 of sufficient size and height for raising the toughness of the top plate part 5a of the top cover 5 may be maintained in the area of the major surface of the top plate part excluding the range of movement of the first rotational arm 35 and the second rotational arm 36.

With the disc drive device 1, described above, sufficient toughness of the top cover 5 can be maintained, such that, even in case the top cover 5 is reduced in thickness and weight, in order to reduce the size and weight of the overall device, the operational reliability in the chuck operation of the optical disc 2 may be assured.

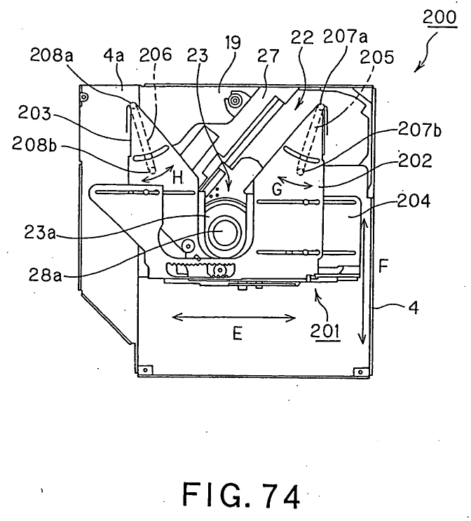

The present invention is not limited to the above-described configuration of the disc drive device 1, and may, for example, be a disc drive device 200 shown for example in FIG. 74. In the following explanation, parts or components similar to those of the disc drive device 1 are not explained and depicted by the same reference numerals in the drawings.

This disc drive device 200 includes, in place of the disc transporting mechanism 34, a disc transport mechanism 201, shown in FIG. 33. This disc transport mechanism 201 includes, as a support member movable between the major surface of the top plate part 5a facing the disc loading unit 23 and the major surface of the optical disc 2 introduced via the disc inserting/ejecting opening 19, a first slide plate 202 and a second slide plate 203, slidable within a plane parallel to the major surface of the optical disc 2.

The first slide plate 202 and the second slide plate 203 are arranged on both sides of the disc loading unit 23 and is supported on a support plate 204, provided on the major surface of the top plate part 5a facing the disc loading unit 23, for sliding in a direction towards and away from each other, that is, in a direction indicated by an arrow E in FIG. 31. On the other hand, the support plate 204 is supported on the major surface of the top plate part 5a facing the disc loading unit 23, for sliding movement in the inserting/ejecting direction of the optical disc 2, that is, in a direction indicated by arrow F perpendicular to the direction of the arrow E in FIG. 31.

On the major surfaces of the first slide plate 202 and the second slide plate 203, facing the disc loading unit 23, a first rotational arm 205 and a second rotational arm 206 are mounted for rotation in a direction towards and away from each other, that is, in the directions indicated by arrows G and H in FIG. 31. On both ends of the first rotational arm 205 and on both ends of the second rotational arm 206 are mounted a first forward surface side abutment member 207a, first back surface side abutment member 207a, a second forward surface side abutment member 208a and a second back surface side abutment member 208b for being protruded towards the lower side, so that these abutment members will be abutted against the outer rim of the optical disc 2 inserted via the disc inserting/ejecting opening 19.

In the above-described disc drive device 200, the first rotational arm 205 and the second rotational arm 206 are rotated in a direction towards and away from each other, as the first slide plate 202 and the second slide plate 203 are slid in a direction towards and away from each other, whereby the optical disc 2, introduced via the disc inserting/ejecting opening 19, is sandwiched between the first forward surface side abutment member 207a and the first back surface side abutment member 207b, on one hand, and the second forward surface side abutment member 208a and the second back surface side abutment member 208b on the other hand. The support plate 204 is slid in this state to the disc loading position, whereby the loading operation of retracting the optical disc 2 to the disc loading position is executed. With the present disc driving device 200, the centering operation of setting the optical disc 2 in the disc loading position is executed, as the optical disc 2 is retracted inwards to the disc loading position. On the other hand, with the present disc driving device 200, the optical disc 2 is ejected via disc inserting/ejecting opening 19 to outside the casing 3 by the reverse of the operation described above. These operations of loading, centering and ejecting the optical disc 2 may be applied to optical discs of differing outer diameters, that is, the large diameter disc 2A with the diameter of 12 cm and the small diameter disc 2B with the diameter of 8 cm.

With the present disc driving device 200, similarly to the disc driving device 1, the operations of loading, centering and ejecting the optical discs 2A, 2B of differing outer diameters, may be carried out adequately in stability, without being affected by the clearance between the base member 27 and the optical disc 2 introduced via disc inserting/ejecting opening 19. In addition, the overall device may be further reduced in size and in thickness.

The present invention is not limited to a disc drive device for the slot-in disc driving device 1 or 200, loaded on the above-described notebook personal computer 1000, but may be broadly applied to a disc drive device for recording and/or reproducing information signals for optical discs.

1. A disc driving device comprising
a casing having a disc inserting/ejecting opening in a front surface thereof;
a base unit including a disc loading unit, loaded with an optical disc inserted via said disc inserting/ejecting opening into the inside of said casing;
a disc rotating and driving mechanism for rotating and driving the optical disc loaded on said disc loading unit;
an optical pickup for writing and/or reading out signals for the optical disc rotated and driven by said disc rotating and driving mechanism; and
an optical pickup feed unit for feeding the optical pickup across the inner and outer rims of the optical disc;
said disc loading unit, disc rotating and driving mechanism, optical pickup and the optical pickup feed unit being formed as one with a base member; and
a disc transport mechanism for transporting said optical disc between a disc inserting/ejecting position of inserting/ejecting the optical disc via said disc inserting/ejecting opening and a disc loading position of loading said optical disc on said disc loading unit;
said disc transport mechanism including a plurality of support members moved between the major surface of said casing facing said disc loading unit and the major surface of the of the optical disc introduced via said disc inserting/ejecting opening;
said plural support members including abutment parts that may be abutted against the outer rim of the optical disc introduced via said disc inserting/ejecting opening, and executing at least one of the loading operation of retracting said optical disc via said disc inserting/ejecting opening into the inside of said casing, the centering operation of setting said optical disc in said disc loading position, and the ejecting operation of ejecting said optical disc to outside said casing through said inserting/ejecting opening, as the outer rim of said optical disc is sandwiched by said abutment parts.

2. The disc drive device according to claim 1 wherein said support members are capable of coping with optical discs of differing outer diameters.

3. The disc drive device according to claim 2 wherein said optical discs of differing outer diameters are a large diameter disc with a diameter of 12 cm and a small diameter disc with a diameter of 8 cm.

4. The disc drive device according to claim 1 wherein said abutments are provided for protruding from the major surfaces of said support members facing said disc loading unit.

5. The disc drive device according to claim 4 wherein said abutments are rolls mounted for rotation to the major surfaces of said support members facing said disc loading unit.

6. The disc drive device according to claim 4 wherein said abutments include flanges at distal ends thereof.

7. The disc drive device according to claim 1 wherein said abutments are formed of resin softer than the material of said optical disc.

8. The disc drive device according to claim 1 wherein said support members are formed of metal sheets.

9. The disc drive device according to claim 1 wherein said support members are rotational members rotatable within a plane parallel to the major surface of the optical disc inserted via said disc inserting/ejecting opening by having said abutment parts formed at the distal ends thereof and by having the proximal parts supported for rotation.

10. The disc drive device according to claim 9 wherein the major surface of said casing facing said disc loading unit is provided with a guide member for guiding the distal end of said rotational member under regulating the distal ends of said rotational members in the height-wise direction.

11. The disc drive device according to claim 10 wherein the distal ends of said rotational members are engaged in a guide groove formed between the major surface of the casing facing said disc loading unit and said guide member.

12. The disc drive device according to claim 11 wherein the major surface of said casing facing said disc loading unit is provided with a work window for engaging the distal ends of said rotational members in said guide groove.

13. The disc drive device according to claim 9 wherein
said plural support members are a first rotational member and a second rotational member, arranged on left and right sides of said disc loading unit of said casing, with the proximal ends of said first and second rotational members, located closer to the back surface side than said disc loading unit, being rotationally supported, and with the distal ends of said first and second rotational members, located closer to the front surface side than said disc loading unit, being first and second rotational members rotatable in a plane parallel to the major surface of said optical disc introduced via said disc inserting/ejecting opening;
said first rotational member and the second rotational member including a plurality of abutment parts that may be abutted against the outer rim of an optical disc of a large diameter and an optical disc of a small diameter; said optical disc of the large diameter and the optical disc of the small diameter being sandwiched on the inner sides of said abutment parts for positioning said optical discs in said disc loading position by way of centering said optical disc.

14. The disc drive device according to claim 13 wherein
said casing includes a lower casing formed to a substantially flat plate shape and a top plate closing an upper opening of said lower casing;
there being mounted a guide member on the front surface side of said top plate for guiding said first rotational member and the second rotational member in a direction towards and away from each other under regulating the distal ends of said first rotational member and the second rotational member in a height-wise direction.

15. The disc drive device according to claim 14 wherein the distal end of said rotational member is engaged in a guide groove formed between said top plate and the guide member.

16. The disc drive device according to claim 14 wherein a work window for engaging the distal end of said first rotational member and the distal end of said second rotational member in said guide groove is formed in said top plate.

17. The disc drive device according to claim 13 wherein said casing includes a lower casing formed to a flat box shape and a top plate closing said opening formed in said lower casing, and wherein
a reinforcement bead for raising the toughness of the major surface of said top plate facing the disc loading unit is provided in an area of said top plate excluding the range of rotation of said first rotational member and the second rotational member.

18. The disc drive device according to claim 17 wherein said bead is provided in an area of said top plate ahead and in rear of a location facing said disc loading unit between said first rotational member and the second rotational member.

19. The disc drive device according to claim 1 wherein said support member is a slide member slidably carried on the major surface of said casing facing said disc loading unit.

20. The disc drive device according to claim 1 further comprising
a base lift mechanism for uplifting/lowering said base, said base lift mechanism uplifting/lowering said base between a chuck position of loading said optical disc set in said disc loading position on said disc loading unit and a chuck releasing position releasing said optical disc from said disc loading unit.

21. The disc drive device according to claim 20 wherein said disc loading unit includes a turntable, rotationally driven by said disc rotating and driving mechanism, an engagement projection formed at the center of said turntable for engagement in said center opening, and a plurality of retention pawls for retaining the rim of the center opening of said optical disc engaged by said engagement projection;
said casing including, in its major surface facing said disc loading unit, an opening through which said engagement projection is exposed to outside during the chuck operation, and an abutment projection as a raised rim of said opening extending towards said disc loading unit;
said base lift mechanism operating so that, when said base is raised to said chuck position, said engagement projection is intruded into said center opening of said optical disc, set in the disc loading position, to thrust the abutment projection against the rim of the center opening of the disc to engage said engagement projection in said center opening of said optical disc to hold said optical disc on said turntable, with the retention pawls retaining the rim of the center opening of the optical disc, by way of performing the chuck operation of loading the optical disc on said disc loading unit.

22. The disc drive device according to claim 21 further comprising
a hoist member provided on the bottom surface section of said casing for protruding upwards from the vicinity of the disc loading unit;
said base lift mechanism operating so that, when said base has been lowered to said chuck releasing position, the distal end of said hoist member is abutted against a non-recording area on the inner rim side of said optical disc, loaded on said disc loading unit, to uplift said optical disc to release said optical disc from the disc loading unit by way of the performing the chuck releasing operation.

23. The disc drive device according to claim 20 wherein the signal recording and/or reproducing operation for said optical disc is carried out as said base lift mechanism holds said base in an intermediate position between said chuck position and the chuck releasing position.

24. A disc driving device comprising
a casing having a disc inserting/ejecting opening for inserting optical disc of different outer diameters, namely a large diameter optical disc and a small diameter optical disc in a front surface;
a base including a disc loading unit, loaded with said optical disc inserted via said disc inserting/ejecting opening into the inside of said casing;
a disc rotating and driving mechanism for rotating and driving the optical disc loaded on said disc loading unit;
an optical pickup for writing and/or reading out signals for the optical disc rotated and drive by said disc rotating and driving mechanism; and
an optical pickup feed unit for feeding the optical pickup across the inner and outer rims of the optical disc;
said disc loading unit, disc rotating and driving mechanism, said optical pickup and the optical pickup feed unit being formed as one with a base member; and
a disc transport mechanism for transporting said optical discs of differing outer diameters between a disc inserting/ejecting position of inserting/ejecting the optical discs via said disc inserting/ejecting opening and a disc loading position of loading said optical disc on said disc loading unit;
said disc transport mechanism including a first rotational member and a second rotational member, arranged on left and right sides of said disc loading unit of said casing, with the proximal ends of said first and second rotational members, located closer to the back surface side than said disc loading unit, being rotationally supported, and with the distal ends of said first and second rotational members, located closer to the front surface side than said disc loading unit, being rotatable in a direction towards and away from each other in a plane parallel to the major surface of said optical disc introduced via said disc inserting/ejecting opening;
said first rotational member and the second rotational member including a plurality of abutment parts that may be abutted against the outer rim of said large diameter optical disc and the small diameter optical disc, introduced via said disc inserting/ejecting opening; wherein
when said large diameter optical disc and the small diameter optical disc are sandwiched on the inner sides of said abutment parts, the center openings of said optical discs and the center part of said disc loading unit are in register with each other in a direction perpendicular to the major surface of the optical disc.

25. The disc drive device according to claim 24 wherein said large diameter optical disc has a diameter of 12 cm and said small diameter optical disc has a diameter of 8 cm.

26. The disc drive device according to claim 24 wherein three or more of said abutment parts are provided at at least three locations out of a location in said first rotational member lying ahead of said disc loading unit, a location in said first rotational member lying in rear of said disc loading unit, a location in said second rotational member lying ahead of said disc loading unit, and a location in said second rotational member lying in rear of said disc loading unit.

27. The disc drive device according to claim 24 wherein said first rotational member and the second rotational member are arranged substantially symmetrically on both sides of said disc loading unit.

28. The disc drive device according to claim 27 wherein the center of rotation of said first rotational member is coincident with the center of rotation of second rotational member.

29. The disc drive device according to claim 27 further comprising
an interlock mechanism for interlocking the operation of said first rotational member with that of said second rotational member, wherein
said first rotational member and the second rotational member are rotated in relatively opposite directions via said interlock mechanism.

30. The disc drive device according to claim 29 wherein said interlock mechanism includes a first connecting member and a second connecting member interconnecting said first rotational member and the second rotational member; said first connecting member and the second connecting member having one ends rotationally carried by the proximal ends of said first rotational member and the second rotational member; said first connecting member and the second connecting member having the other ends rotationally carried via support shafts engaged in guide slits provided towards the forward surface side with respect to the center of rotation of said first rotational member and the second rotational member to form a pantographic structure;
said first rotational member and the second rotational member being rotated in opposite directions relative to each other through said first connecting member and the second connecting member by said support shafts being slid in the fore-and-aft directions in said guided slit.

31. The disc drive device according to claim 30 wherein said guide slit is an elongated opening formed for extending along the inserting/ejecting direction of said optical disc; there being a curved section formed at a mid portion of said elongated opening for extending in one of the leftward and rightward directions; wherein
in case the small diameter optical disc is inserted from a position offset towards the other of the leftward and rightward directions of said disc inserting/ejecting opening, said first rotational member and the second rotational member are rotated in a direction away from each other through said interlock mechanism, however, said support shafts are caught by said curved section to inhibit rotation of said first rotational member and the second rotational member in a direction away from each other to prohibit further insertion of said small diameter optical disc.

32. The disc drive device according to claim 24 wherein said disc transport mechanism includes biasing means for biasing said first rotational member and the second rotational member in a direction towards each other;
said first rotational member and the second rotational member including a first abutment part and a second abutment part, respectively, at distal ends thereof, the outer rim of sand optical disc being sandwiched between said first and second abutment parts; said optical disc being thrust, under the biasing force of said biasing means, in a direction of being retracted into the inside of said casing through said disc inserting/ejecting opening, when the center of the disc is located closer to the back surface side than a straight line interconnecting said first and second abutment parts; said optical disc being thrust under the biasing force of said biasing means, when the center of the disc is located closer to the forward surface side than a straight line interconnecting said first and second abutment parts, in a direction of being ejected to outside said casing through said disc inserting/ejecting opening.

33. The disc drive device according to claim 32 wherein said disc transport mechanism operates so that, as said optical disc is inserted into the inside of said casing through said disc inserting/ejecting opening, said first rotational member and the second rotational member hold the outer rim of the optical disc in-between the first abutment part and the second abutment part, said first abutment part and the second abutment part are abutted against the back surface side of the outer rim of the optical disc and, in this state, said first rotational member and the second rotational member are rotated in a direction away from each other against the bias of said biasing means, and so that, after the first abutment part and the second abutment part have turned around from the back surface side to the front surface side along the outer rim of said optical disc, said first abutment part and the second abutment part are abutted against the forward surface side of the outer rim of the optical disc and, in this state, the first rotational member and the second rotational member are rotated in a direction towards each other under the biasing force of said biasing means, whereby said optical disc is retracted into the inside of said casing through said disc inserting/ejecting opening.

34. The disc drive device according to claim 33 wherein said disc transport mechanism includes loading assisting means for assisting in the loading operation.

35. The disc drive device according to claim 34 wherein said loading assisting means includes a third rotational member arranged on one of the left and right sides on both sides of said disc loading unit of said casing; the proximal end of said third rotational member, located closer to the forward surface side than the disc loading unit, being rotationally supported; the distal end of said third rotational member being swung within a plane parallel to the major surface of the optical disc introduced via said disc insertion/ejection opening;
said third rotational member including, at the distal end thereof, a third abutment part thrust against the outer rim of the optical disc inserted via said disc inserting/ejecting opening; said third rotational member being rotated towards the back surface side as said third abutment part is abutted against the forward surface side of the outer rim of said optical disc so that the optical disc is thrust in a direction of being retracted into the inside of said casing through said disc insertion/ejection opening until at least the center of the disc is located closer to the back surface side than a straight line interconnecting said first and second abutment parts.

36. The disc drive device according to claim 32 wherein said disc transport mechanism includes ejection assisting means for assisting in the operation of ejecting said optical disc to outside said casing via said disc inserting/ejecting opening.

37. The disc drive device according to claim 36 wherein said ejection assisting means includes a fourth rotational member arranged on one of the left and right sides on both sides of said disc loading unit of said casing; the proximal end of said fourth rotational member, located closer to the back surface side than the disc loading unit, being rotationally supported; the distal end of said fourth rotational member being swung within a plane parallel to the major surface of the optical disc introduced via said disc insertion/ejection opening;
said fourth rotational member including, at the distal end thereof, a fourth abutment part thrust against the outer rim of the optical disc inserted via said disc inserting/ejecting opening; said fourth rotational member in a state of being thrust against the back surface side of the outer rim of the optical disc being rotated towards the forward surface side so that the optical disc is thrust in a direction of being ejected to outside said casing through said disc insertion/ejection opening until at least the center of the disc is located closer to the forward surface side than a straight line interconnecting said first and second abutment parts.

38. The disc drive device according to claim 37 wherein said disc transport mechanism operates so that, as said fourth abutment part is abutted against the back surface side of the outer rim of the optical disc in the disc loading position, and as said fourth abutment part is rotated towards the forward surface side, said first abutment part and the second abutment part are abutted against the forward surface side of the outer rim of the optical disc and, in this state, said first rotational member and the second rotational member are rotated in a direction away from each other against the bias of said biasing means, and so that, after the first abutment part and the second abutment part have turned around from the forward surface side to the back surface side along the outer rim of said optical disc, along the outer rim of said optical disc, said first abutment part and the second abutment part are abutted against the back surface side of the outer rim of the optical disc and, in this state, the first rotational member and the second rotational member are rotated in a direction towards each other under the bias of said biasing means, whereby said optical disc is ejected to outside of said casing through said disc inserting/ejecting opening.

39. The disc drive device according to claim 38 wherein said first abutment part and the second abutment part are each provided with a pair of rolls mounted for rotation on the distal ends of said first rotational member and the second rotational member, respectively.

40. The disc drive device according to claim 37 wherein said ejection assisting means includes a fifth rotational member, mounted for rotation on the opposite side to said fourth rotational member, at a position closer to the back surface side than the disc loading unit of one of said first rotational member and the second rotational member, said fifth rotational member being rotated in a plane parallel to the major surface of the optical disc inserted via said disc inserting/ejecting opening, in association operatively with the rotation of said one rotational member, by a gear formed on the outer rim of said fifth rotational member meshing with an internal gear arranged within said casing;
said fifth rotational member including a fifth abutment part thrust against the outer rim of the optical disc inserted via said disc inserting/ejecting opening; said fifth rotational member in a state of being thrust against the back surface side of the outer rim of the optical disc being rotated towards the forward surface side so that the optical disc is thrust in a direction of being ejected to outside said casing through said disc insertion/ejection opening until at least the center opening of the disc is located closer to the forward surface side than a straight line interconnecting said first and second abutment parts.

41. The disc drive device according to claim 24 comprising
a driving lever arranged on the bottom surface section of said casing for sliding in the fore-and-aft direction; and
a driving mechanism for displacing and driving said driving lever;
said first rotational member and the second rotational member being rotated in a direction towards and away from each other in association operatively with the sliding of said driving lever by said driving mechanism.

42. The disc drive device according to claim 30 or 41 wherein
said disc transport mechanism includes a cam lever slid in the left-and-right direction along the back side surface of said base, in association operatively with the sliding of said driving lever caused by said driving mechanism;
said cam lever including a first cam and a second cam located closer to the forward surface side than said first cam; wherein
in case said large diameter optical disc is inserted, said support shafts are engaged by said second cam and slid in said guide slit in association operatively with the sliding movement of said driving lever and said cam lever caused by said driving mechanism, whereby said first rotational member and the second rotational member are rotated in a direction towards and away from each other in keeping with the large diameter optical disc; and wherein
in case said small diameter optical disc is inserted, said support shafts are engaged by said second cam and slid in said guide slit in association operatively with the sliding movement of said driving lever and said cam lever caused by said driving mechanism, whereby said first rotational member and the second rotational member are rotated in a direction towards and away from each other in keeping with the small diameter optical disc

43. The disc drive device according to claim 41 wherein
said disc transport mechanism includes a slide member mounted to the back surface side of said driving lever for sliding in the fore-and-aft direction of said driving lever, and a tension coil spring having a back surface side end thereof retained by said slide member and having a forward surface side end thereof retained by said driving lever.

44. The disc drive device according to claim 41 wherein
said disc transport mechanism includes a thrusting member rotated between an abutting position thrust against one of said first rotational member and the second rotational member and a retreated position spaced apart from said one rotational member, and biasing means for biasing said thrusting member in a direction of approaching said first and second rotational members towards each other, as said thrusting member is abutted against said one rotational member; and wherein
said thrusting member includes a cam pin engaged in a cam groove formed in an upper surface section of said driving lever; said thrusting member being rotated to said retreated position, against the bias of said biasing means, in case said driving lever is slid to the back surface side end, with said cam pin sliding in said cam groove, in association operatively with the sliding of said driving lever caused by said driving mechanism.

45. The disc drive device according to claim 35 or 41 wherein
said third rotational member has a proximal end thereof rotationally carried by a support shaft and includes a substantially L-shaped shaft opening passed through by said support shaft and a cam pin engaged in a cam groove formed in an upper surface section of said driving lever;
said third rotational member being rotated in association operatively with the sliding of said driving lever, caused by said driving mechanism, as said cam pin is slid in said cam groove, the center of rotation of said third rotational member being changed over depending on the position of the supporting shaft within said shaft opening.

46. The disc drive device according to claim 45 wherein
said loading assisting means includes biasing means for biasing said third rotational member in the rotational direction, said biasing means changing over the direction of the biasing force of biasing said third rotational member in association operatively with sliding of said driving lever caused by said driving mechanism.

47. The disc drive device according to claim 37 or 41 wherein
said ejection assisting means includes a connection mechanism for interconnecting said fourth rotational member and said driving member; and wherein
said fourth rotational member is rotated, through said connection mechanism, in association operatively with the sliding of said driving lever caused by said driving mechanism.
